(19) United States
(12) Patent Application Publication
(10) Pub. No.: US 2017/0103357 A1
(43) Pub. Date: Apr. 13, 2017

(54) TASK-SPECIFYING DEVICE, TASK-SPECIFYING METHOD, AND RECORDING MEDIUM

(71) Applicant: NEC Corporation, Minato-ku, Tokyo (JP)

(72) Inventor: Eriko NUMATA, Tokyo (JP)

(73) Assignee: NEC Corporation, Minato-ku, Tokyo (JP)

(21) Appl. No.: 15/129,458

(22) PCT Filed: Apr. 16, 2015
(86) PCT No.: PCT/JP2015/002094

§ 371 Date: Sep. 27, 2016

(30) Foreign Application Priority Data
Apr. 21, 2014 (JP) 2014-087444

(51) Int. Cl. G06Q 10/06

(52) U.S. Cl. CPC G06Q 10/06316; G06Q 10/0635

(57) ABSTRACT

To provide a task-specifying device that enable specification of a task which is needed for consensus building and information conveyance in a collaborative work between stakeholders but is missing from recognition of each of the stakeholders. The task-specifying device 1a comprising: a matter-of-concern task model generation means that generates a matter-of-concern task model that structuralizes a relationship among an activity included in stakeholder information indicating a content of an action of a stakeholder, a matter of concern to which the activity belongs, and a task detailing the activity; a task-specifying model generation means that generates a task-specifying model that structuralizes a relationship among a matter of concern needed at an arbitrary point of time in a development process, an activity to be accomplished relating to the needed matter of concern, and a task detailing the activity; and a task extraction means that compares a task in the matter-of-concern task model with a task in the task-specifying model and extracts a difference.

### TECHNICAL FIELD

The present invention relates to a task-specifying device and the like that are applied to a development process for a system.

### BACKGROUND ART

As a trend of a shorter life cycle of business as well as globalization thereof progresses, a quick and flexible response is desired for system development in Information Technology (IT) vendor companies. To make this possible, system development using agile development and iterative development has been carried out. For the system development, cooperative work in an IT vendor company or between an IT vendor company and a user company is important throughout all steps in a development process, unlike a project management method such as process-based development in which the process is sectioned into stages. To enhance quality of the cooperative work, what is most import are consensus building and information conveyance based on communication among stakeholders. In the present application, a “stakeholder” refers to a decision maker involved in a development process. Specifically, a “stakeholder” indicates a planner and a budget manager in a planning phase, a person in charge of design in a design phase, and the like.

However, when a role such as a responsibility, a phase, and an attribute is different for each stakeholder, there is a difference in matters of concern among the stakeholders. Accordingly, this often leads to a gap in communication among the stakeholders. A matter of concern herein refers to a matter with which each stakeholder is concerned from a viewpoint of the role.

NPL 1 discloses a technique that relates to Software Engineering Method and Theory (SEMAT), which is one of software development methods. The technique disclosed in NPL 1 aims to manage software development, based on several kinds of matters of concern across a development process, with a task relating to each of the matters of concern, rather than managing software development with a process.

PTL 1 describes a device that analyzes a log of organization communication. PTL 1 discloses a technique of determining a factor in activation and inactivation of communication in an organization, by using a quantitatively analyzable electronic mail and an electronic bulletin board and combining pieces of qualitative information.

PTL 2 discloses a technique of managing progress of a plurality of tasks respectively associated with a plurality of components, by extracting components, such as work contents carried out in a team, tasks, and deliverables, with use of a Work Breakdown Structure (WBS).

### CITATION LIST

### Patent Literature

[PTL 1] Japanese Unexamined Patent Application Publication No. 2003-85347

[PTL 2] Japanese Unexamined Patent Application Publication No. 2009-245285

### Non Patent Literature

[NPL 1] Ivar Jacobson, Pan Wei Ng, Paul E. Mcmahon, Ian Spence, Svante Lidman, The Essence of Software Engineering: The SEMAT Kernel, ACM queue, vol. 10, No. 10, pp. 40, 2012

### SUMMARY OF INVENTION

### Technical Problem

To carry out smooth communication among stakeholders in a development process for a system, it is necessary to clarify a difference in matters of concern for each of the stakeholders, which may be a cause of a communication gap. This clarification enables specification of a task which is needed for consensus building and information conveyance but is missing from recognition of each of the stakeholders.

In the SEMAT described in NPL 1, roughly three items are defined. The three items include: seven matters of concern across a development process; Kernel Alphas indicating states of the respective matters of concern; and check matters for checking degrees of achievement of Kernel Alphas. Using respective cards in which the defined three items are written, development is managed. The cards are arranged in a time sequence in accordance with contents of Kernel Alphas based on the matters of concern. A position of a card is changed depending on whether a check matter written in the card has been carried out. Confirmation of carrying out the check matter written in the card is performed among stakeholders being involved at the point of time. In the SEMAT, although it is possible to manage development on a task basis, it is impossible to clarify matters of concern among the respective stakeholders. In other words, it is impossible to specify a task which is missing from recognition among stakeholders involved in development.

In PTL 1, a factor in activation and inactivation of communication in an organization is determined by analyzing a log of the communication in the organization. However, it is impossible to specify a factor in a difference in recognition of each stakeholder, which serves as a basis of communication.

In PTL 2, since the WBS is essential in managing progress of a task, managing a project is impossible without the WBS. Further, similarly to PTL 1, it is impossible to specify a factor in a difference in recognition of each stakeholder.

A main object of the present invention is to provide a task-specifying device and the like that enable specification of a task which is needed for consensus building and information conveyance in a collaborative work between stakeholders but is missing from recognition of each of the stakeholders.

### Solution to Problem

To achieve the above-described object, a task-specifying device and the like according to the present invention include the following configuration. Note that in the present invention, a matter of concern of each stakeholder is assumed to be constituted of an activity constituting the matter of concern and tasks detailing the activity at executable levels.

First aspect of the present invention is a task-specifying device. The device includes:

a matter-of-concern task model generation means that generates a matter-of-concern task model that structuralizes a relationship among an activity included in stakeholder information indicating a content of an action of a stakeholder, a matter of concern to which the activity belongs, and a task detailing the activity;

a task-specifying model generation means that generates a task-specifying model that structuralizes a relationship among a matter of concern needed at an arbitrary point of time in a development process, an activity to be accomplished relating to the needed matter of concern, and a task detailing the activity; and

a task extraction means that compares a task in the matter-of-concern task model with a task in the task-specifying model and extracts a difference.

Second aspect of the present invention is a task-specifying method. The method includes:

generating a matter-of-concern task model that structuralizes a relationship among an activity included in stakeholder information indicating a content of an action of a stakeholder, a matter of concern to which the activity belongs, and a task detailing the activity;

generating a task-specifying model that structuralizes a relationship among a matter of concern needed at an arbitrary point of time in a development process, an activity to be accomplished relating to the needed matter of concern, and a task detailing the activity; and

comparing a task in the matter-of-concern task model with a task in the task-specifying model and extracting a difference.

Third aspect of the present invention is a recording medium that stores a task-specifying program. The program causing a computer to execute processing of:

generating a matter-of-concern task model that structuralizes a relationship among an activity included in stakeholder information indicating a content of an action of a stakeholder, a matter of concern to which the activity belongs, and a task detailing the activity;

generating a task-specifying model that structuralizes a relationship among a matter of concern needed at an arbitrary point of time in a development process, an activity to be accomplished relating to the needed matter of concern, and a task detailing the activity; and

comparing a task in the matter-of-concern task model with a task in the task-specifying model and extracting a difference.

### Advantageous Effects of Invention

The present invention enables specification of a task which is needed for consensus building and information conveyance in a collaborative work between stakeholders and which is missing from recognition of each of the stakeholders.

### BRIEF DESCRIPTION OF DRAWINGS

FIG. 1 is a block diagram illustrating a configuration example of a task-specifying device according to a first exemplary embodiment of the present invention.

FIG. 2 is an explanatory diagram schematically illustrating communication between stakeholders at a point of time in a development process.

FIG. 3A is a diagram illustrating a data structure of stakeholder information (input information).

FIG. 3B is a diagram illustrating a data structure of a role matter-of-concern correspondence list.

FIG. 3C is a diagram illustrating a data structure of a standard activity list.

FIG. 3D is a diagram illustrating a data structure of a standard task list.

FIG. 4 is an explanatory diagram illustrating an example of an accomplished activity list.

FIG. 5 is a diagram illustrating the concept of a structure of a matter-of-concern task model.

FIG. 6 is a diagram illustrating an example of a main matter-of-concern model at an arbitrary point of time in a development process.

FIG. 7 is a diagram illustrating a structure of a task-specifying model.

FIG. 8 is a flowchart illustrating an operation of specifying a difference task in the task-specifying device according to the first exemplary embodiment of the present invention.

FIG. 9 is a flowchart illustrating an operation of generating a matter-of-concern task model for each stakeholder in the task-specifying device according to the first exemplary embodiment of the present invention.

FIG. 10 is a diagram illustrating an example of stakeholder information.

FIG. 11 is a diagram illustrating an example of a role matter-of-concern correspondence list.

FIG. 12 is a diagram illustrating an example of a matter-of-concern.

FIG. 13 is a diagram illustrating an example of a standard activity list.

FIG. 14 is a diagram illustrating an example of a standard task list.

FIG. 15A is a diagram illustrating an example of a matter-of-concern task model.

FIG. 15B is a diagram illustrating an example of a matter-of-concern task model.

FIG. 16 is a diagram abstractly illustrating a series of flows for processing of generating a matter-of-concern task model by collating input information for each stakeholder with each of lists.

FIG. 17 is a flowchart illustrating an operation of generating a task-specifying model in the task-specifying device according to the first exemplary embodiment of the present invention.

FIG. 18 is an explanatory diagram illustrating an example of an accomplished activity list.

FIG. 19 is an explanatory diagram abstractly illustrating a series of flows for processing of collating input information for a stakeholder with the accomplished activity list illustrated in FIG. 18.

FIG. 20 is an explanatory diagram abstractly illustrating a series of flows for processing of generating a main matter-of-concern model at Step S308.

FIG. 21 is an explanatory diagram illustrating an example of a main matter-of-concern model.

FIG. 22 is an explanatory diagram abstractly illustrating a series of flows for processing of generating a task-specifying model by using a main matter-of-concern model and a standard task list through Steps S309 to S311.

FIG. 23 is an explanatory diagram illustrating an example of a task-specifying model.

FIG. 24 is a flowchart illustrating an operation of searching a matter-of-concern task model and a task-specifying model in the task-specifying device according to the first exemplary embodiment of the present invention.

FIG. 25 is an explanatory diagram illustrating an example of a screen for displaying the content of a difference task.

FIG. 26 is a block diagram illustrating a task-specifying device according to a second exemplary embodiment of the present invention.

FIG. 27 is a block diagram illustrating a modification example of the task-specifying device according to the second exemplary embodiment of the present invention.

### DESCRIPTION OF EMBODIMENTS

### First Exemplary Embodiment

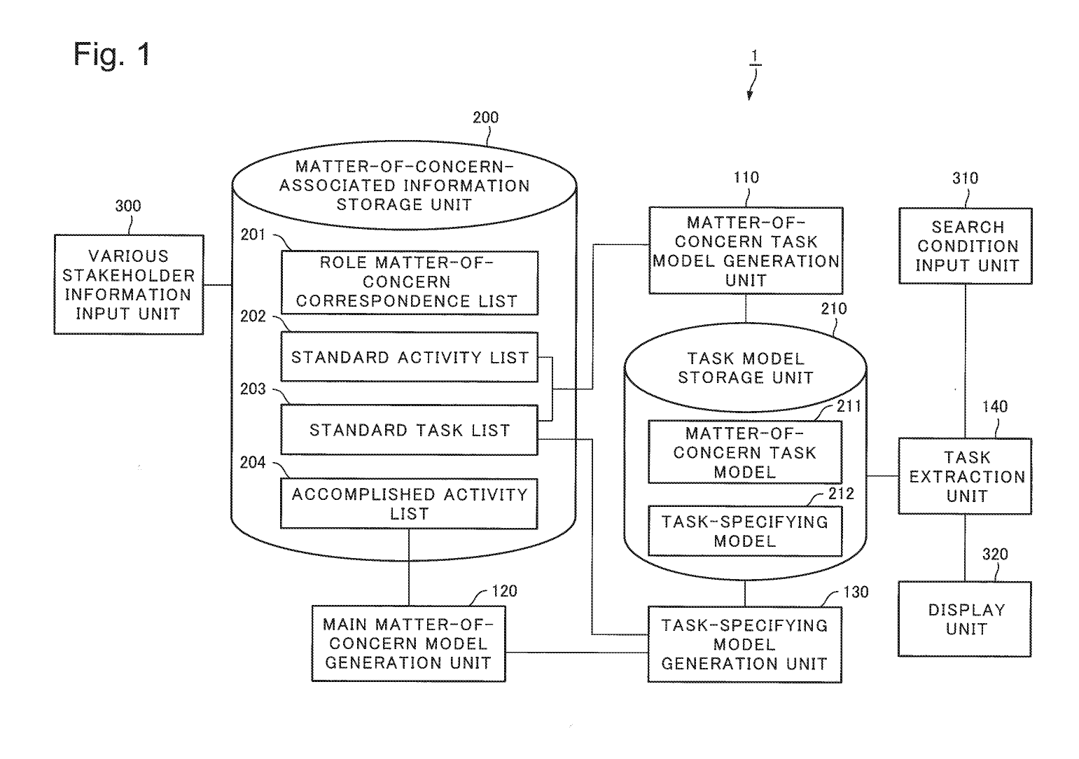

A first exemplary embodiment of the present invention is described below with reference to the drawings. FIG. 1 is a block diagram illustrating a configuration of task-specifying device 1 according to the first exemplary embodiment of the present invention.

Task-specifying device 1 includes matter-of-concern task model generation unit 110, main matter-of-concern model generation unit 120, task-specifying model generation unit 130, task extraction unit 140, matter-of-concern-associated information storage unit 200,task model storage unit 210, various stakeholder information input unit 300, search condition input unit 310, and display unit 320.

Stakeholder information input through an operation by an operator or the like is output to matter-of-concern-associated information storage unit 200. The stakeholder information includes information relating to a role (hereinafter, referred to as a “role”) and information relating to an activity (hereinafter, referred to as an “activity”). Note that a role refers to a mission of a stakeholder and an activity refers to an action necessary for accomplishing the mission. The stakeholder information is used in various stakeholder information input unit 300, Matter-of-concern task model generation unit 110, main matter-of-concern model generation unit 120, and task-specifying model generation unit 130.

Search condition input unit 310 transmits, to task extraction unit 140, a search condition (the role and the activity included in each piece of the stakeholder information) input through an operation by an operator or the like.

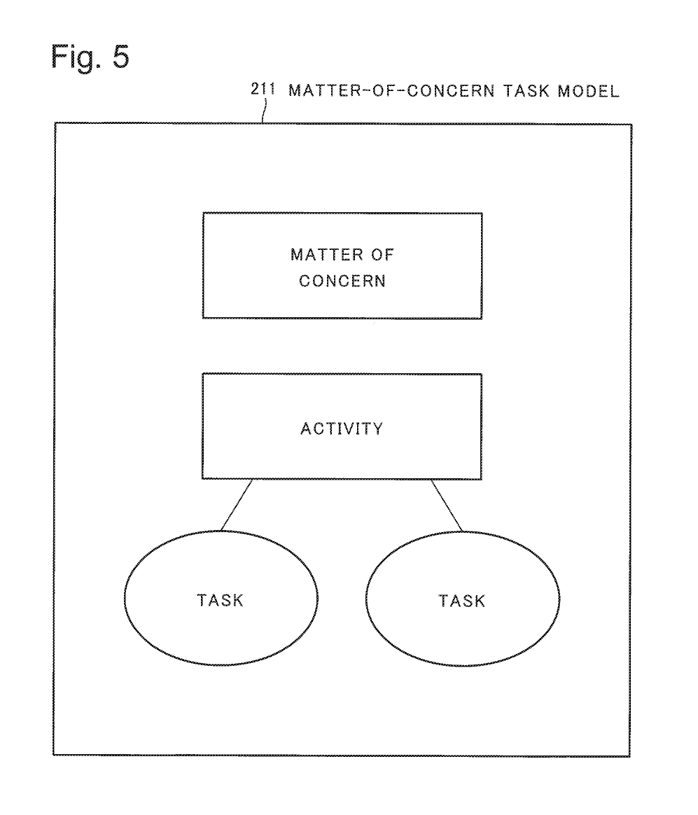

Matter-of-concern task model generation unit 110 generates a matter-of-concern task model 211 (see FIG. 5) that constitutes, by using a tree structure, information extracted from matter-of-concern-associated information storage unit 200, based on the stakeholder information input from various stakeholder information input unit 300. A matter of concern refers to a work which is needed at an arbitrary point of time in a development process and to which each of stakeholders particularly gives interest (pays attention). The stakeholder information includes an activity (first activity) indicating a content of an action of a stakeholder. The information extracted from matter-of-concern-associated information storage unit 200 refers to information indicating a matter of concern, an activity, and a task. Matter-of-concern task model generation unit 110 stores, in task model storage unit 210, information that associates the role and the activity included in the stakeholder information input from various stakeholder information input unit 300 with the generated matter-of-concern task model 211. The structure of the matter-of-concern task model 211 will be described later in detail.

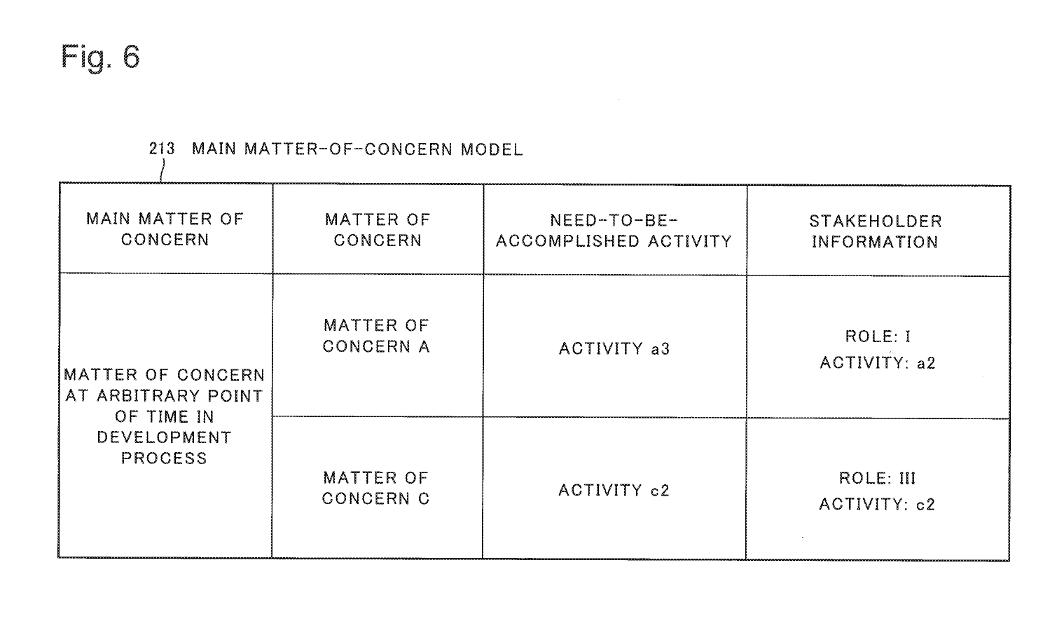

Main matter-of-concern model generation unit 120 generates a main matter-of-concern model 213 (see FIG. 6) that structuralizes a correspondence relationship between a plurality of activities input from matter-of-concern-associated information storage unit 200 and matters of concern to which the respective activities belong. Main matter-of-concern model generation unit 120 manages information that associates the role and the activity included in the stakeholder information input from various stakeholder information input unit 300 with a main matter of concern. The structure of main matter-of-concern model 213 will be described later in detail.

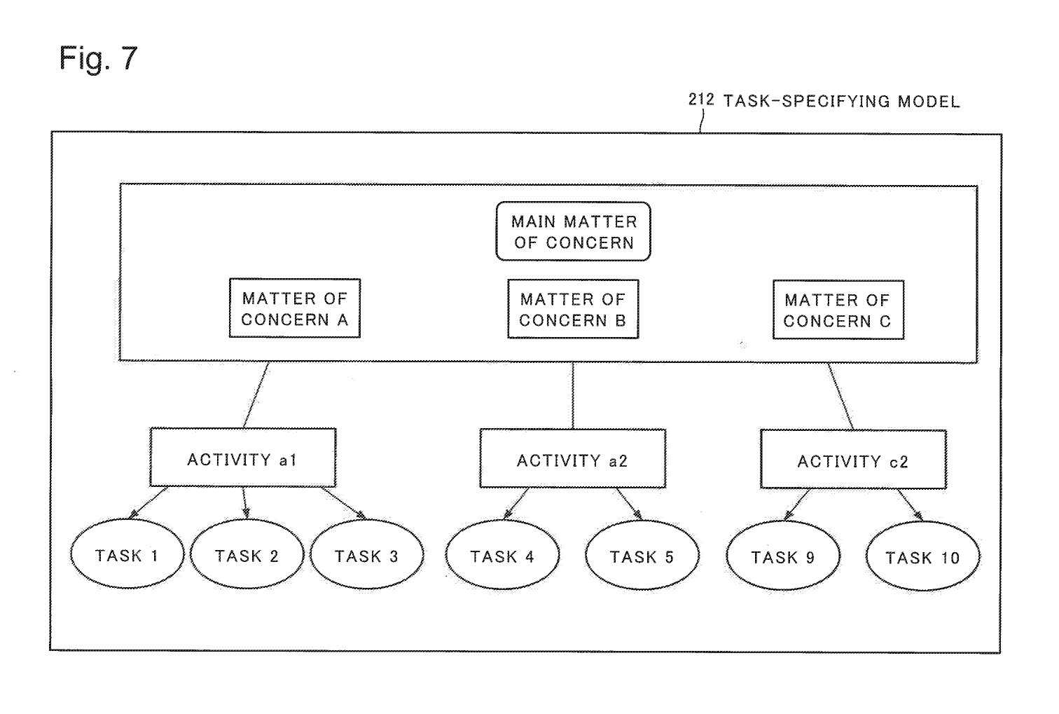

Task-specifying model generation unit 130 generates a task-specifying model 212 (see FIG. 7) that structuralizes, by using a tree structure, a correspondence relationship among matters of concern associated with a main matter of concern, activities associated with the matters of concern, and tasks associated with the activities. The matters of concern refer to matters of concern which constitute main matter-of-concern model 213 at a point of time generated by main matter-of-concern model generation unit 120. The output tasks refer to tasks acquired from matter-of-concern-associated information storage unit 200, based on information on activities in main matter-of-concern model 213. The activities associated with the matters of concern herein refer to activities (second activities) to be accomplished relating to the respective matters of concern.

Task-specifying model generation unit 130 stores, in task model storage unit 210, information that associates the role and the activity included in stakeholder information input from various stakeholder information input unit 300 with the generated task-specifying model 212. The structure of task-specifying model 212 will be described later in detail.

Task extraction unit 140 searches for information stored in task model storage unit 210 based on a search condition input from Search condition input unit 310, and displays a result of the search on display unit 320.

Specifically, task extraction unit 140 searches, by using a role and an activity included in each piece of the input stakeholder information as a search condition, the matter-of-concern task model 211 included in each piece of the associated stakeholder information and task-specifying model 212 in task model storage unit 210. Task extraction unit 140 compares tasks in the matter-of-concern task model 211 for each of the stakeholders with tasks in task-specifying model 212, which are the results of the search, and extracts a difference between the tasks. Task extraction unit 140 outputs, to display unit 320, information on the extracted difference between the tasks, and the matter-of-concern task model 211 for each of the stakeholders and task-specifying model 212, which are the results of the search.

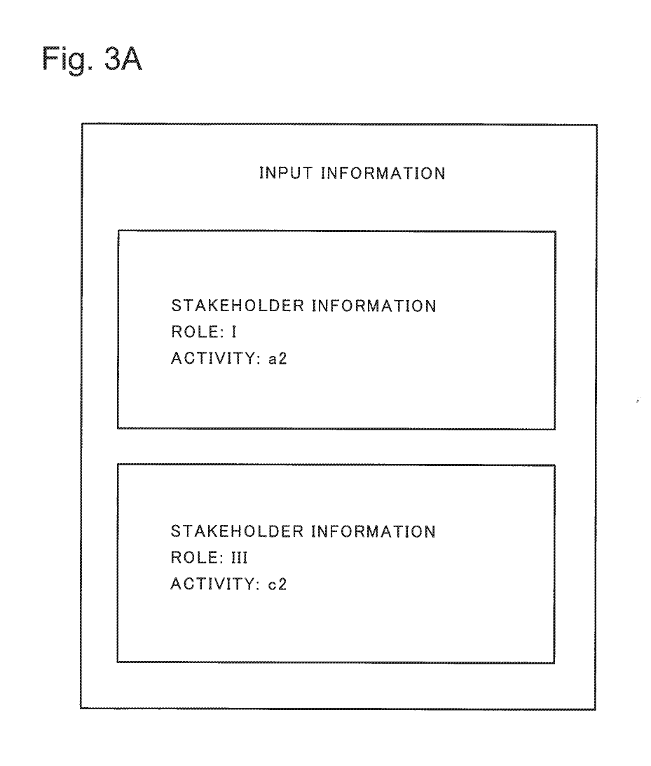

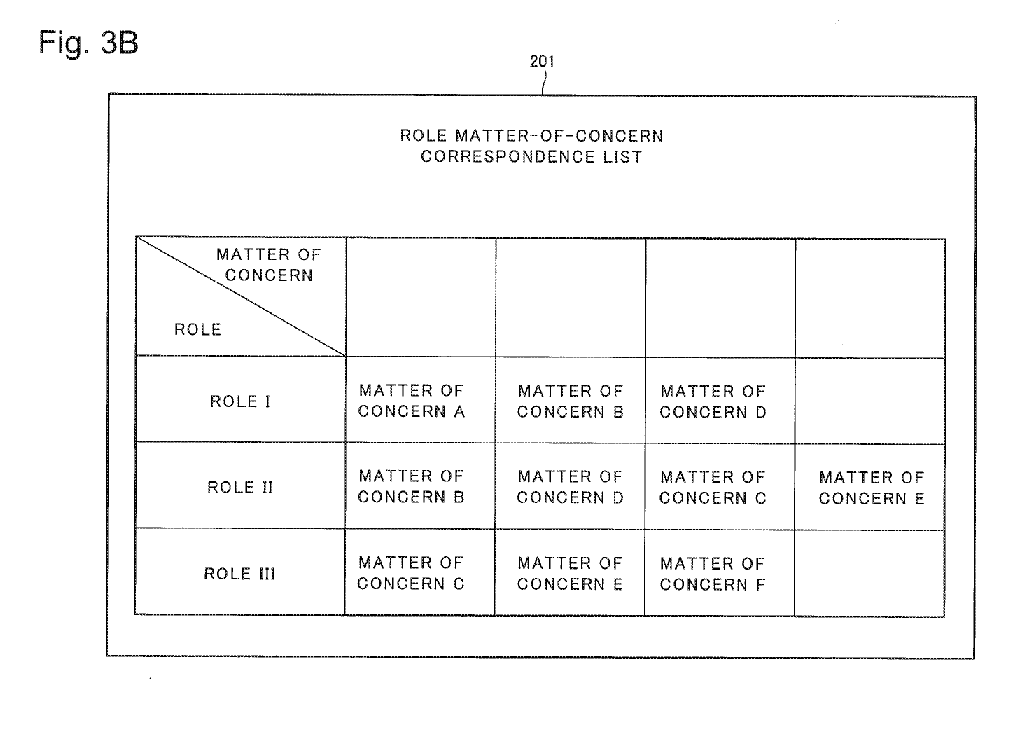

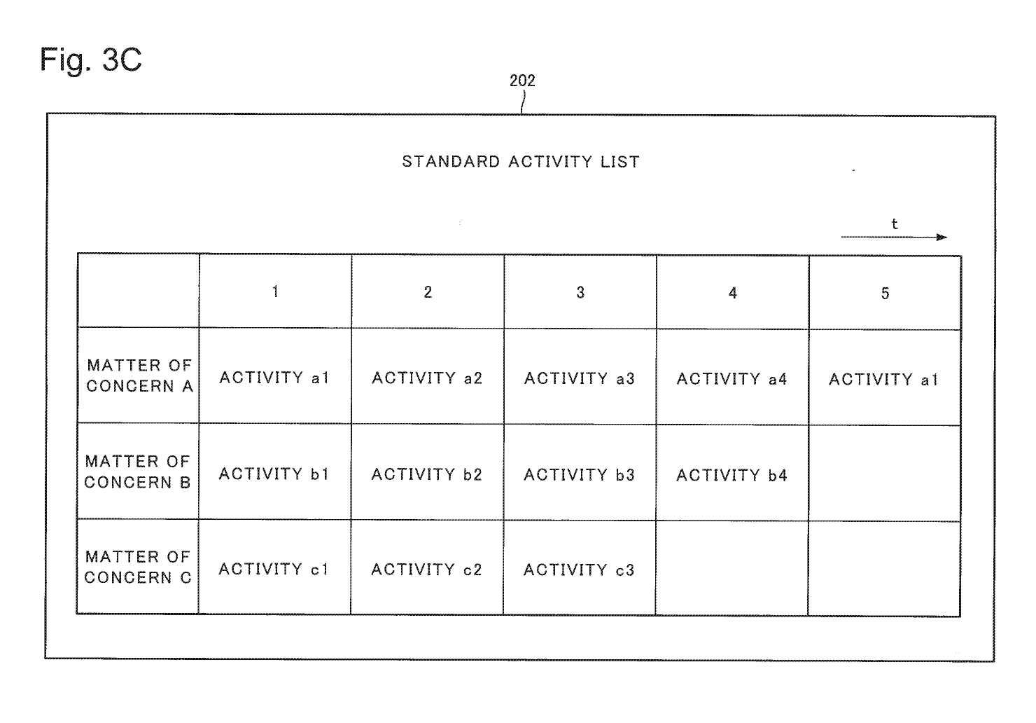

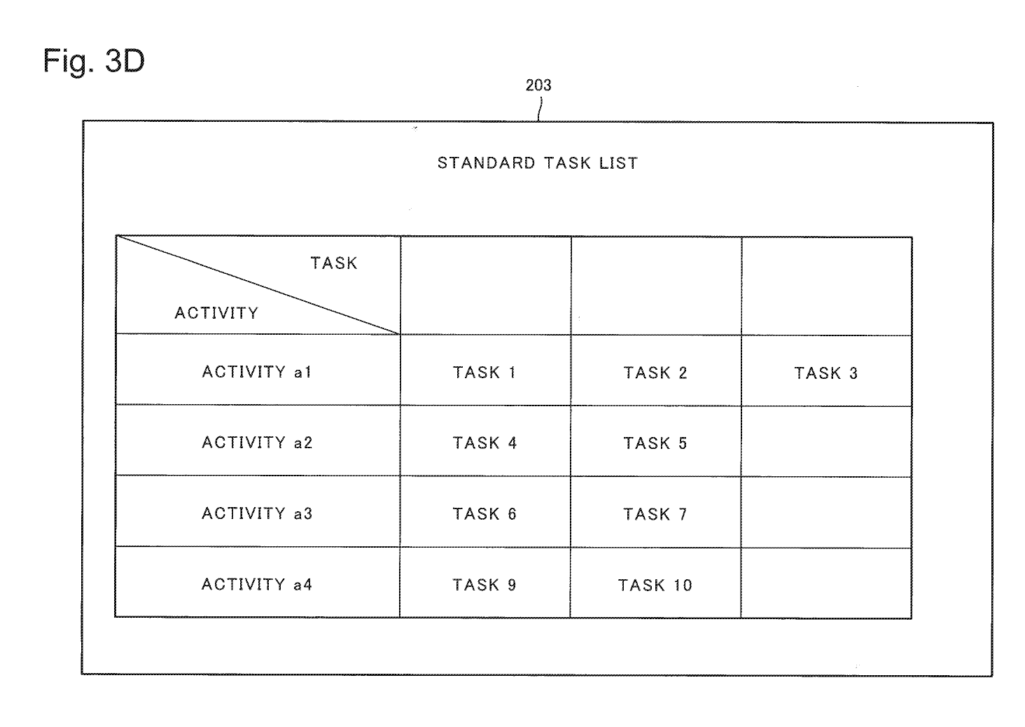

Matter-of-concern-associated information storage unit 200 includes a storage device (not illustrated) such as a memory, and stores, in the storage device, role matter-of-concern correspondence list 201, standard activity list 202, standard task list 203, and accomplished activity list 204 which are preliminarily defined or created by a user or the like. Matter-of-concern-associated information storage unit 200 searches the lists 201 to 204 stored therein for pieces of information necessary for matter-of-concern task model generation unit 110 and main matter-of-concern model generation unit 120 to create a model, based on the input information (stakeholder information (see FIG. 3A) input from various stakeholder information input unit 300, and outputs the pieces of information to respective generation units 110 and 120.

When the stakeholder information is input from various stakeholder information input unit 300, matter-of-concern-associated information storage unit 200 collates the role included in the stakeholder information with role matter-of-concern correspondence list 201 (see FIG. 3B), and extracts a plurality of matters of concern relating to the role. Matter-of-concern-associated information storage unit 200 collates the plurality of extracted matters of concern with standard activity list 202 (see FIG. 3C), and extracts a plurality of activities constituting each of the matters of concern. Matter-of-concern-associated information storage unit 200 collates the plurality of extracted activities with the activity included in the stakeholder information input from various stakeholder information input unit 300, and specifies a matter of concern to which the activity included in the input stakeholder information belongs. Matter-of-concern-associated information storage unit 200 outputs, to matter-of-concern task model generation unit 110, information that associates the specified matter of concern with the role included in the stakeholder information.

In addition, when the stakeholder information is input from various stakeholder information input unit 300, matter-of-concern-associated information storage unit 200 collates standard task list 203, extracts tasks relating to the activity included in the stakeholder information, and outputs, to matter-of-concern task model generation unit 110, the extracted tasks and the role included in the stakeholder information in association with each other.

In this manner, matter-of-concern-associated information storage unit 200 outputs, to matter-of-concern task model generation unit 110, information that associates the “matter of concern” and the “tasks” extracted from the lists 201 to 204 stored in its own with the “role” and the “activity” included in the stakeholder information based on the stakeholder information input from various stakeholder information input unit 300.

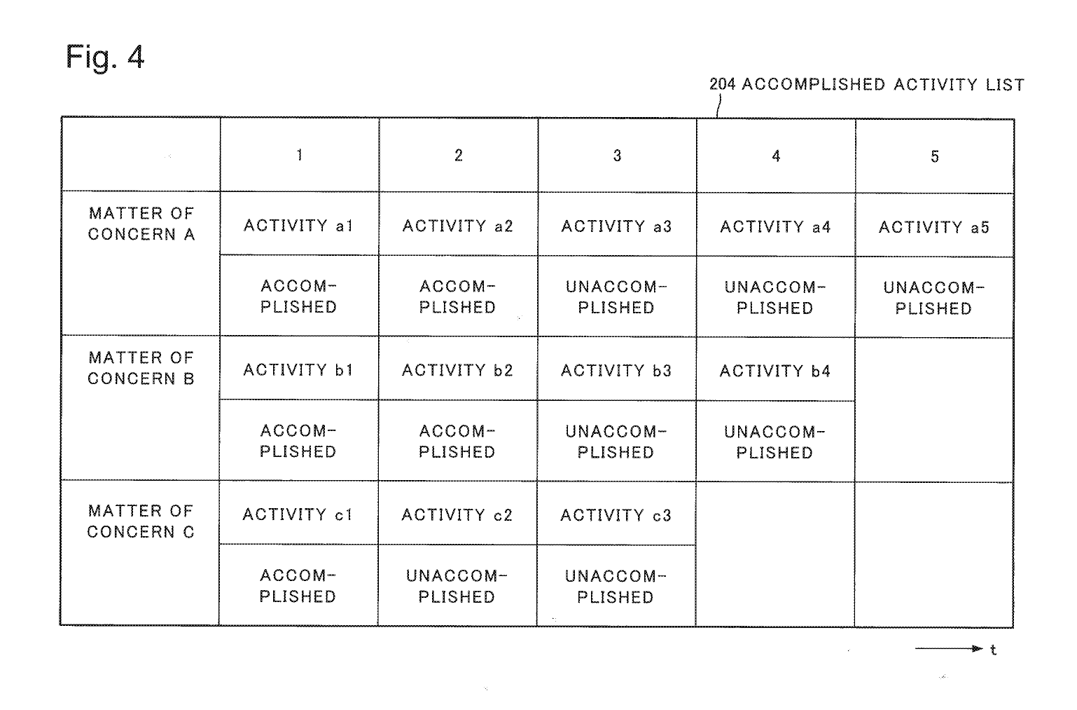

When the stakeholder information is input from various stakeholder information input unit 300, matter-of-concern-associated information storage unit 200 collates accomplished activity list 204 (see FIG. 4). As a result of the collation, matter-of-concern-associated information storage unit 200 outputs, to main matter-of-concern model generation unit 120, information that associates a matter of concern to which an activity determined as being unaccomplished belongs and the input stakeholder information with the activity.

Matter-of-concern-associated information storage unit 200 determines, based on the activity included in the input stakeholder information, whether the activity is registered in accomplished activity list 204 as an accomplished activity. Further, matter-of-concern-associated information storage unit 200 determines whether there is an unaccomplished activity to be accomplished prior to the aforementioned activity. After the determination, matter-of-concern-associated information storage unit 200 outputs information on the activity determined as being unaccomplished to main matter-of-concern model generation unit 120. Further, matter-of-concern-associated information storage unit 200 registers the activity determined as being unaccomplished in accomplished activity list 204 as an accomplished activity.

Matter-of-concern-associated information storage unit 200 performs the above-described processing for the number of pieces of stakeholder information input from various stakeholder information input unit 300.

Task model storage unit 210 stores a matter-of-concern task model 211 and a task-specifying model 212 (see FIG. 1). Task model storage unit 210 further stores information that is associated with models generated by matter-of-concern task model generation unit 110 and task-specifying model generation unit 130. The information will be described later in detail.

Matter-of-concern task model generation unit 110 temporarily stores information on a matter of concern, an activity, and tasks extracted from matter-of-concern-associated information storage unit 200 during input of the stakeholder information from various stakeholder information input unit 300 to matter-of-concern-associated information storage unit 200.

Display unit 320 displays a result of search input from task extraction unit 140. Specifically, display unit 320 displays information on an extracted difference between tasks, which is acquired from task extraction unit 140, and the matter-of-concern task model 211 for each stakeholder and task-specifying model 212, which are the result of the search.

Note that matter-of-concern task model generation unit 110, main matter-of-concern model generation unit 120, task-specifying model generation unit 130, task extraction unit 140, matter-of-concern-associated information storage unit 200, various stakeholder information input unit 300, and search condition input unit 310 are implemented by, for example, a computer that operates according to a task-specifying program. In this case, a program storage device (not illustrated) of the computer stores the task-specifying program. A CPU reads the task-specifying program. In accordance with the program, the computer operates as matter-of-concern task model generation unit 110, main matter-of-concern model generation unit 120, task-specifying model generation unit 130, task extraction unit 140, matter-of-concern-associated information storage unit 200, various stakeholder information input unit 300, and search condition input unit 310. In addition, matter-of-concern task model generation unit 110, main matter-of-concern model generation unit 120, task-specifying model generation unit 130, task extraction unit 140, matter-of-concern-associated information storage unit 200, various stakeholder information input unit 300, and search condition input unit 310 may be implemented by separate hardware configurations.

In addition, task model storage unit 210 is implemented by, for example, a storage device such as an optical disk drive, a magnetic disk drive, and a memory included in Task-specifying device 1.

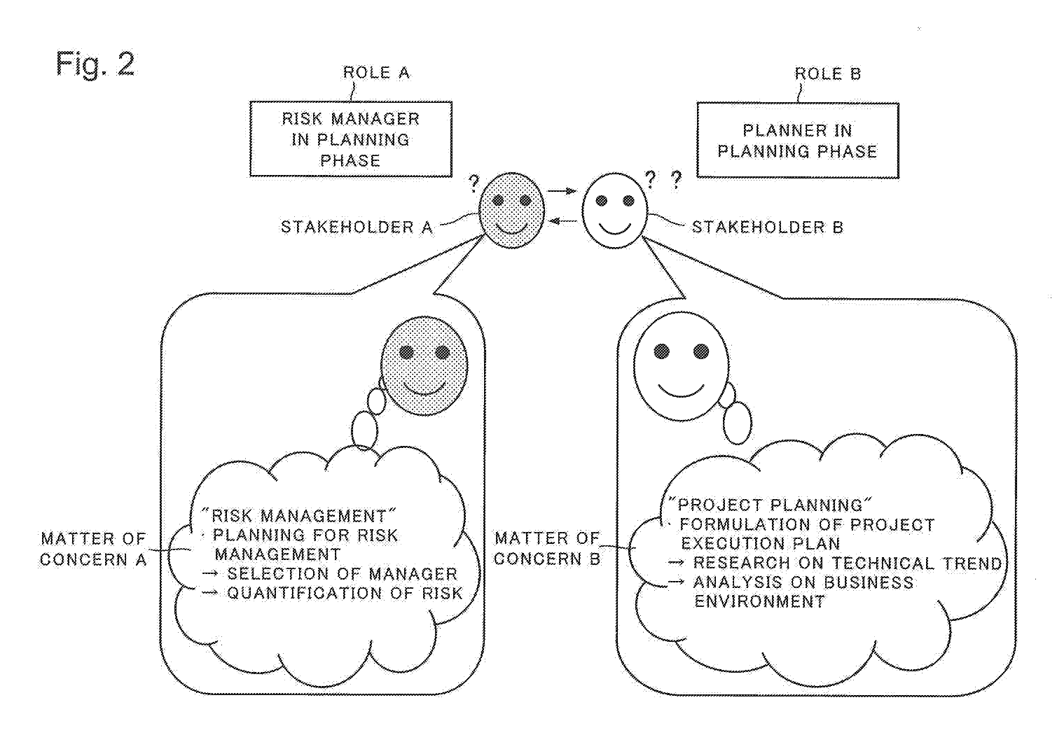

FIG. 2 is an explanatory diagram schematically illustrating communication between stakeholders (A and B) at a point of time in a development process.

Stakeholders A and B each have basically one role (Role A or Role B). Note that Stakeholders A and B may have a plurality of roles. Each of Roles A and B herein is represented by a combination of a development phase in which Stakeholders A and B are involved and their responsible area in the phase. Examples include “Risk manager in Planning phase”, “Planner in Planning phase”, “Person in charge of Budget in Design phase”, and the like.

Matter of concern A “Risk management” illustrated in FIG. 2 represents a matter of concern of Stakeholder A, and Matter of concern B

“Project planning” represents a matter of concern of Stakeholder B. Matter of concern refers to a matter with which Stakeholder A and Stakeholder B are concerned based on a viewpoint of Role A and a viewpoint of Role B, respectively, in a development phase in which both Stakeholders A and B are involved, and is constituted of a plurality of matters of concern for one role. A matter of concern herein includes, in addition to “Risk management” and “Project planning” illustrated in FIG. 2, “Quality assurance”, “Security assurance”, “Schematic design”, “System integration test”, and the like.

As illustrated in FIG. 2, Activity with respect to Matter of concern “Risk management” is “Planning for Risk management”. Activity with respect to Matter of concern “Project planning” is “Formulation of Project implementation plan”. Activity refers to an action with which stakeholders are concerned based on a viewpoint of their role, and is constituted of one or a plurality of activities for one matter of concern. Activity herein is represented by a combination of a development phase in which stakeholders are involved, such as “Planning for Risk management” and “Formulation of Project implementation plan” illustrated in FIG. 2 and “Planning for Outline design”, and their action in the phase.

“Selection of Manager” and “Risk Quantification” illustrated in FIG. 2 represent tasks constituting Activity “Planning for Risk management”. In addition, “Research on Technical trend” and “Analysis on Business environment” illustrated in FIG. 2 represent Tasks constituting Activity “Formulation of Project implementation plan”. Tasks represent contents of an activity detailed at an executable level. One activity is essentially constituted of one or more tasks. When tasks constituting an activity are all completed, the activity is regarded as being accomplished. A task herein refers to an essential matter to accomplish an activity with which stakeholders are concerned, such as “Selection of Manager” illustrated in FIG. 2, “Documentation of Processes”, “Adjustment of Schedule”, and “Calculation of Work estimate”.

A role matter-of-concern correspondence list 201 is a list that defines a correspondence relationship between a role of a stakeholder and one or more matters of concern with which the role is concerned from a viewpoint of the role, as illustrated in FIG. 3B. Collating a role included in stakeholder information with role matter-of-concern correspondence list 201 enables specification of a plurality of matters of concern relating to the role.

A standard activity list 202 is a list that defines a correspondence relationship between a matter of concern and a group of activities constituting the matter of concern, as illustrated in FIG. 3C. A matter of concern is constituted of a group of activities needed across a development process. In standard activity list 202, a group of activities are arranged in a time sequence (t) from left to right (from the left side to the right side in FIG. 3), where an item that is closer to the left side comes earlier in the order to be accomplished. Collating a plurality of matters of concern specified in role matter-of-concern correspondence list 201 with standard activity list 202 enables specification of activities constituting each of the matters of concern. Activities in standard activity list 202 are associated with a matter of concern to which the activities belong. Comparing the activity specified in the collation with standard activity list 202 with an activity included in stakeholder information enables specification of a matter of concern to which the activity included in the stakeholder information belongs.

A standard task list 203 is a list that defines a correspondence relationship between an activity and tasks detailing the activity at executable levels, as illustrated in FIG. 3D. Collating standard task list 203 based on an activity which is stakeholder information enables extraction of tasks.

FIG. 4 is an explanatory diagram illustrating an example of an accomplished activity list 204.

Accomplished activity list 204 is a list which is based on standard activity list 202 and in which whether each of the activities is accomplished or unaccomplished is additionally written within standard activity list 202. Matters of concern defined in accomplished activity list 204 and groups of activities constituting the respective matters of concern include the same contents as standard activity list 202. In addition, similarly to standard activity list 202, a group of activities constituting a matter of concern has an order relationship of a time sequence (t) from left to right (from the left side to the right side in FIG. 4), where an item that is closer to the left side comes earlier in the order to be accomplished.

FIG. 5 is an explanatory diagram illustrating a structure of a matter-of-concern task model 211.

The matter-of-concern task model 211 is a model that structuralizes, by using a tree structure, a matter of concern as a root, an activity as a child node of the matter of concern detailing the matter of concern into a content of an action, and tasks as child nodes of the activity detailing the activity into execution contents. The matter-of-concern task model 211 enables structurization of a matter of concern, an activity, and tasks that each of stakeholders recognizes.

FIG. 6 is an explanatory diagram illustrating an example of a main matter-of-concern model 213 at an arbitrary point of time in a development process.

A main matter of concern refers to a matter of concern that is specified based on information on accomplished activities at an arbitrary point of time in a development process. Specifically, a main matter of concern refers to a matter of concern that includes an unaccomplished activity to be accomplished (hereinafter referred to as a “need-to-be-accomplished activity”) at an arbitrary point of time in a development process as a component, and that is a major concern at an arbitrary point of time in a development process. Main matter-of-concern model 213 may be created with respect to a plurality of main matters of concern. Main matter-of-concern model 213 is a model that includes one or more main matters of concern, one or more matters of concern relating to the main matters of concern, and a need-to-be-accomplished activity relating to each of the matters of concern. By using main matter-of-concern model 213, information on the need-to-be-accomplished activity at a point of time for each of stakeholders can be grasped.

FIG. 7 is an explanatory diagram illustrating a structure of a task-specifying model 212. Task-specifying model 212 is a model that structuralizes pieces of information on a main matter of concern in main matter-of-concern model 213, one or more matters of concern relating thereto, activities relating to the respective matters of concern, and tasks relating to each of the activities. The information on tasks is extracted from matter-of-concern-associated information storage unit 200. By using task-specifying model 212, pieces of information on a main matter of concern, matters of concern, activities, and tasks at a point of time in a development process can be grasped.

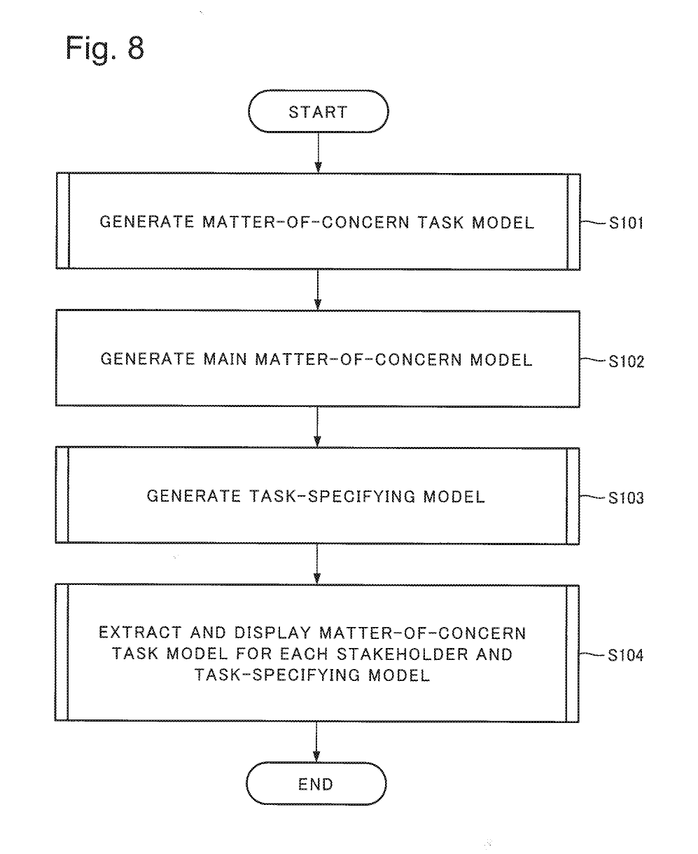

Next, an operation of the present exemplary embodiment is described. FIG. 8 is a flowchart illustrating an operation of specifying a task which is missing from the recognition of each of stakeholders in Task-specifying device 1 illustrated in FIG. 1.

Firstly, at Step S101, an operator or the like inputs each piece of stakeholder information (role and activity). With this as a trigger, matter-of-concern task model generation unit 110 generates a matter-of-concern task model 211 (see FIG. 5) based on pieces of information extracted from role matter-of-concern correspondence list 201, standard activity list 202, and standard task list 203. Matter-of-concern task model generation unit 110 stores, in task model storage unit 210, the generated matter-of-concern task model 211 in association with role information included in the stakeholder information. Processing at Step S101 will be described later in detail.

Next, at Step S102, assume that the operator or the like operates the role and the activity included in each piece of the stakeholder information. With this as a trigger, main matter-of-concern model generation unit 120 generates a main matter-of-concern model 213 at a point of time in a development process, based on information in accomplished activity list 204 of matter-of-concern-associated information storage unit 200. Main matter-of-concern model generation unit 120 then outputs, to task-specifying model generation unit 130, the generated main matter-of-concern model 213 in association with role information included in the stakeholder information.

At Step S103, task-specifying model generation unit 130 generates a task-specifying model 212 (FIG. 7), based on main matter-of-concern model 213 (see FIG. 6) input from main matter-of-concern model generation unit 120 at Step S102, and information in standard task list 203 (see FIG. 3D) stored in matter-of-concern-associated information storage unit 200. Task-specifying model generation unit 130 then stores, in task model storage unit 210, the generated task-specifying model 212 in association with role information included in the stakeholder information. Processing of generating task-specifying model 212 at Steps S102 and S103 will be described later in detail.

At Step S104, task extraction unit 140 extracts, based on a search condition input from search condition input unit 310, the matter-of-concern task model 211 associated with each of stakeholders and task-specifying model 212 which are stored in task model storage unit 210, and displays the matter-of-concern task model 211 and task-specifying model 212 on display unit 320.

Comparing tasks constituting the matter-of-concern task model 211 for each of the stakeholders with tasks constituting task-specifying model 212, which are displayed on display unit 320, through an operation by the operator or the like enables specification of a task which is needed for consensus building and information sharing and which the need is missing from the recognition of each of the stakeholders. Processing at Step S104 will be described later in detail.

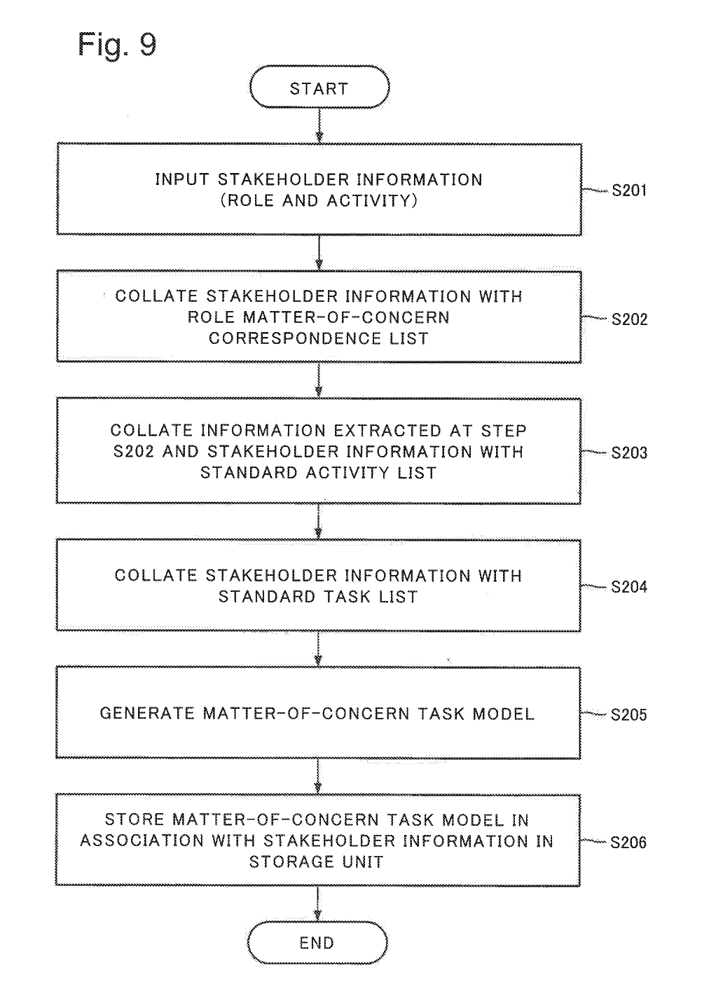

FIG. 9 is a flowchart illustrating an operation (operation at Step S101 in FIG. 8) of generating a matter-of-concern task model 211 for each of stakeholders in Task-specifying device 1.

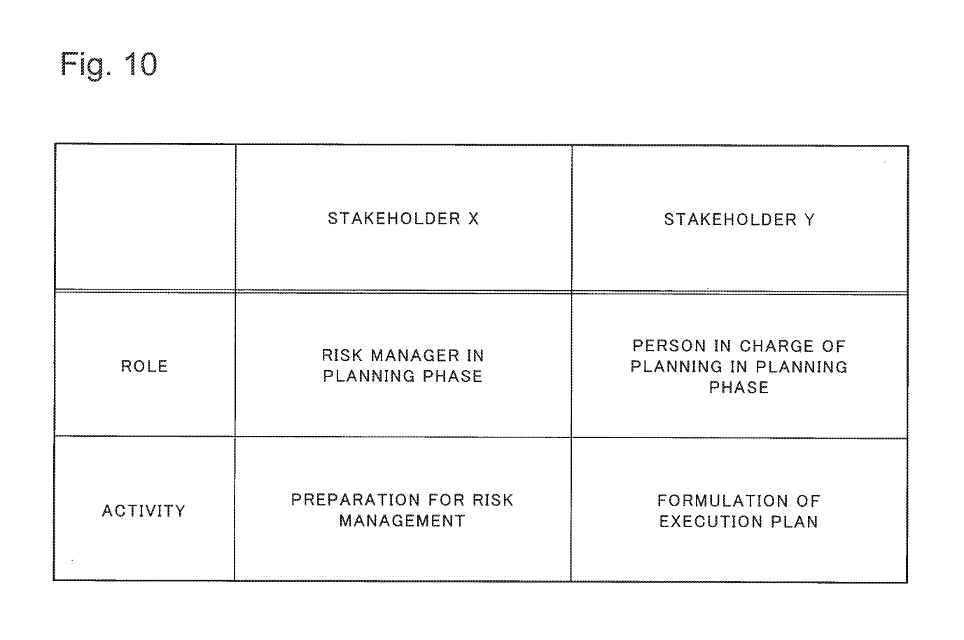

First, at Step S201, stakeholder information is input to various stakeholder information input unit 300 through an operation by an operator or the like. Various stakeholder information input unit 300 outputs the input stakeholder information to matter-of-concern-associated information storage unit 200. As an example, assume that stakeholder information illustrated in FIG. 10 is input. In the stakeholder information, X and Y are present as stakeholders, where Stakeholder X has a role of “Risk manager in Planning phase” and an activity of “Preparation for Risk management”. Stakeholder Y has a role of “Person in charge of Planning in Planning phase” and an activity of “Formulation of Execution plan”.

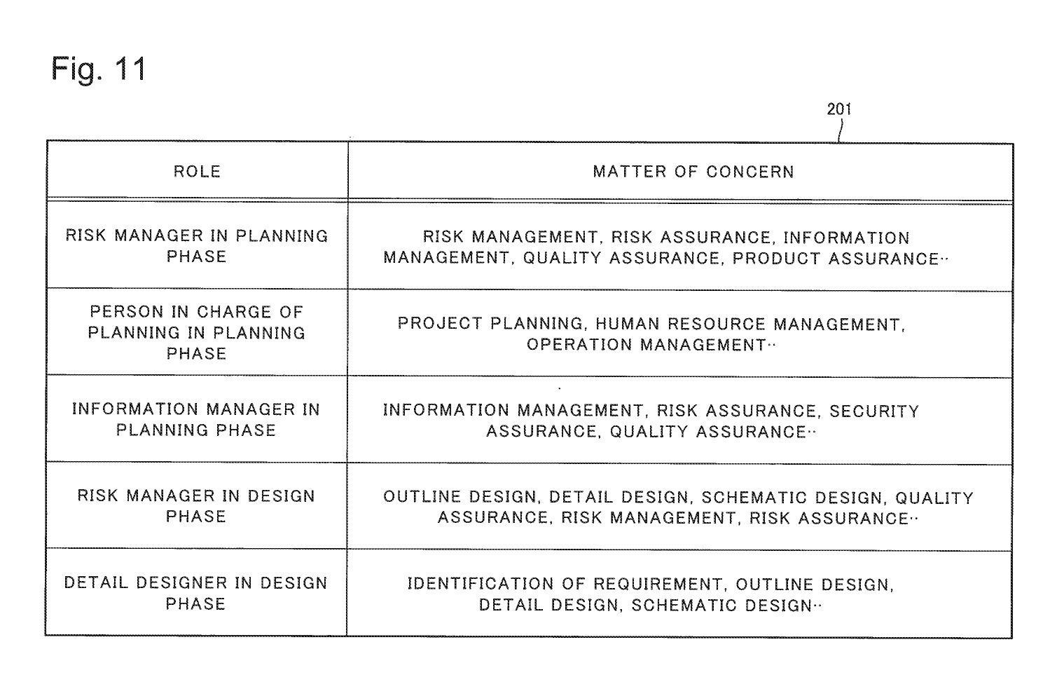

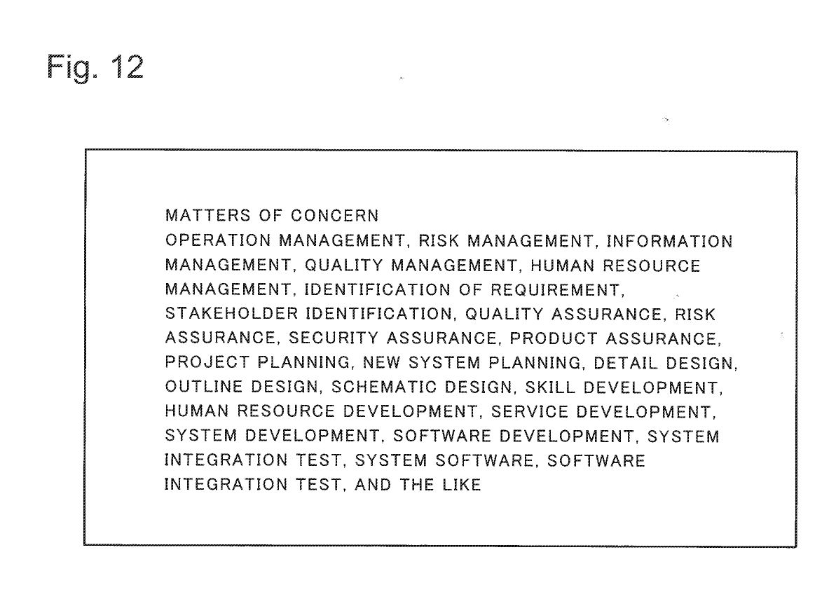

Next, at Step S202, matter-of-concern-associated information storage unit 200 collates, based on a role included in the input stakeholder information, with role matter-of-concern correspondence list 201. Matter-of-concern-associated information storage unit 200 herein specifies a role which is the same as the role included in the input stakeholder information from among roles in role matter-of-concern correspondence list 201, and extracts a group of matters of concern constituting the specified role. For example, assume that role matter-of-concern correspondence list 201 includes contents illustrated in FIG. 11. In this case, when the role included in the stakeholder information is “Risk manager in Planning phase”, a group of matters of concern to be extracted include “Risk management, Risk assurance, Information management, Quality assurance, Product assurance, and the like”. In addition, when the role included in the stakeholder information is “Person in charge of Risk planning in Planning phase”, a group of matters of concern to be extracted include “Project planning, Human resource management, Operation management, and the like”.

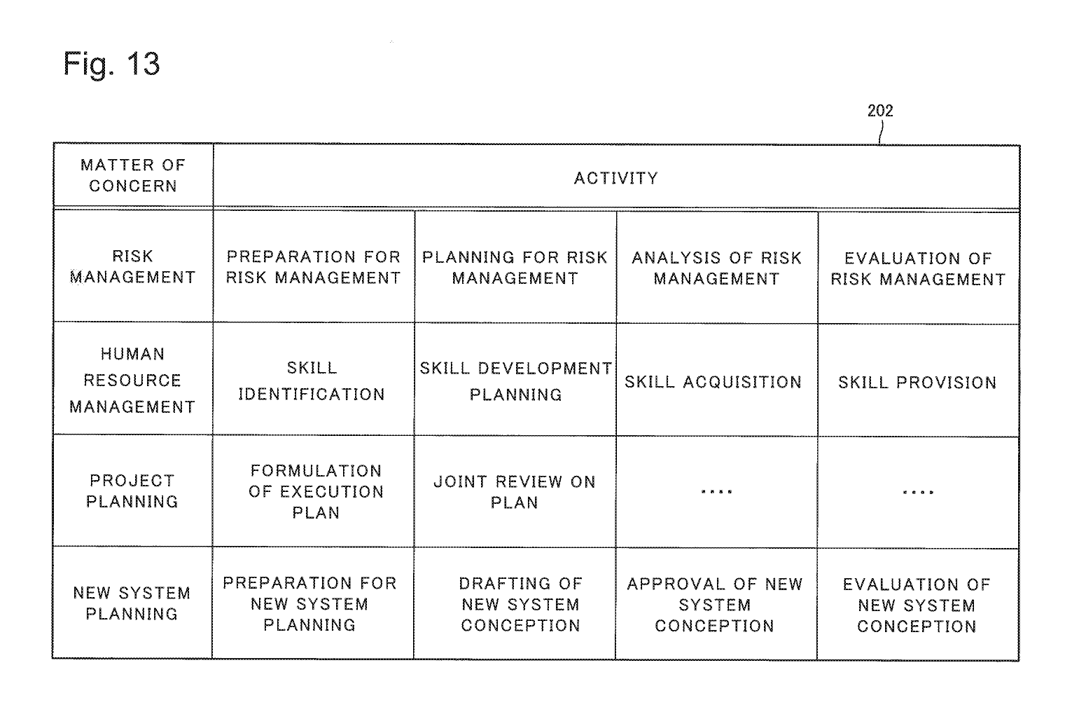

At Step S203, matter-of-concern-associated information storage unit 200 collates each of the group of matters of concern extracted at Step S202 with standard activity list 202 (see FIG. 13). Matter-of-concern-associated information storage unit 200 extracts, from among standard activity list 202, a matter of concern which has the same name as each of the group of matters of concern extracted at Step S202, and extracts a group of activities constituting the extracted matter of concern. For example, assume that standard activity list 202 includes contents illustrated in FIG. 13, and a group of matters of concern extracted at Step S202 include “Risk management”, “New system planning”. In this case, a group of activities to be extracted for “Risk management” include “Preparation for Risk management →Planning for Risk management→Analysis of Risk management →Evaluation of Risk management”. A group of activities to be extracted for “New system planning” include “Preparation for New system planning→Drafting of New system conception→Approval of New system conception→Evaluation of New system conception”.

Matter-of-concern-associated information storage unit 200 collates the extracted group of activities with an activity included in the input stakeholder information, and specifies a matter of concern to which the activity included in the stakeholder information belongs. For example, assume that the extracted group of activities and a matter of concern to which the activities belong are:
“Matter of concern: Risk management

Group of activities: “Preparation for Risk management →Planning for Risk management →Analysis of Risk management →Evaluation of Risk management” and
“Matter of concern: New system planning

Group of activities: Preparation for New system planning →Drafting of New system conception →Approval of New system conception→Evaluation of New system conception”, and
the activity included in the stakeholder information is
“Preparation for Risk management”. In this case, matter-of-concern-associated information storage unit 200 specifies a matter of concern to which the activity included in the stakeholder information is “Risk management”.

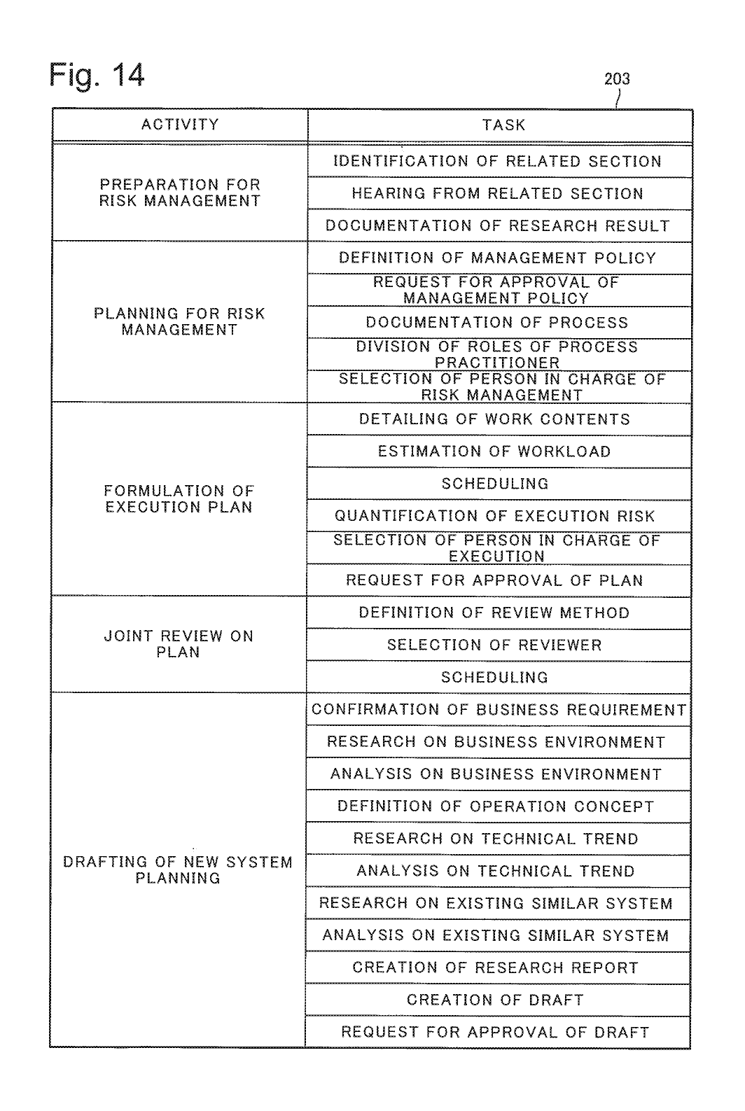

At Step S204, matter-of-concern-associated information storage unit 200 collates, based on the activity included in the input stakeholder information, with standard task list 203 (see FIG. 14). Activities in standard task list 203, and an activity which is the same as the activity included in the input stakeholder information are specified, and a group of tasks constituting the specified activity are extracted. For example, when standard task list 203 includes contents illustrated in FIG. 14, and the activity included in the stakeholder information is “Preparation for Risk management”, a group of tasks to be extracted are “Identification of Related section, Hearing from Related section, and Documentation of Research result”.

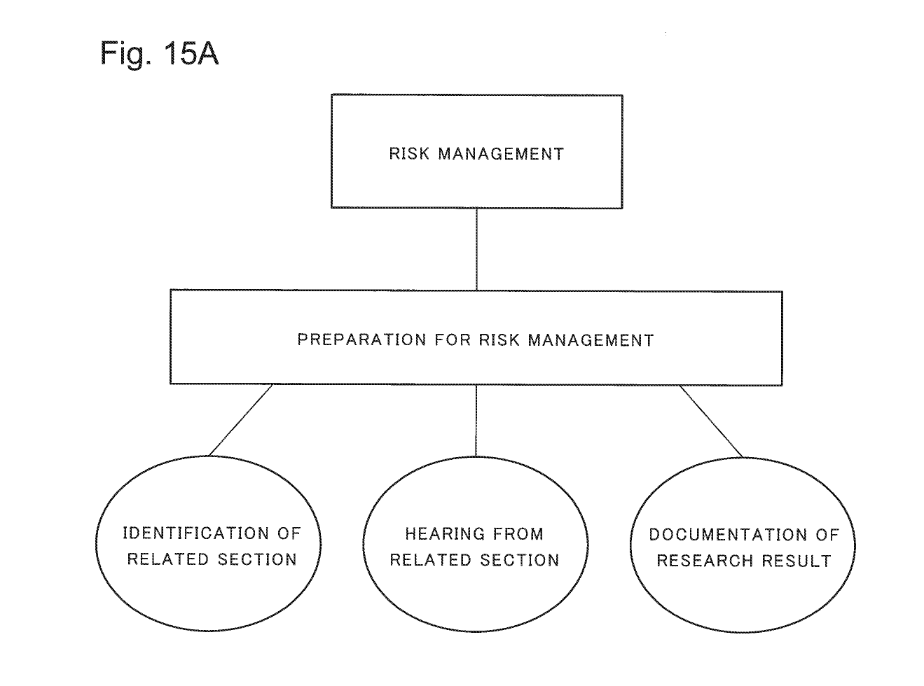

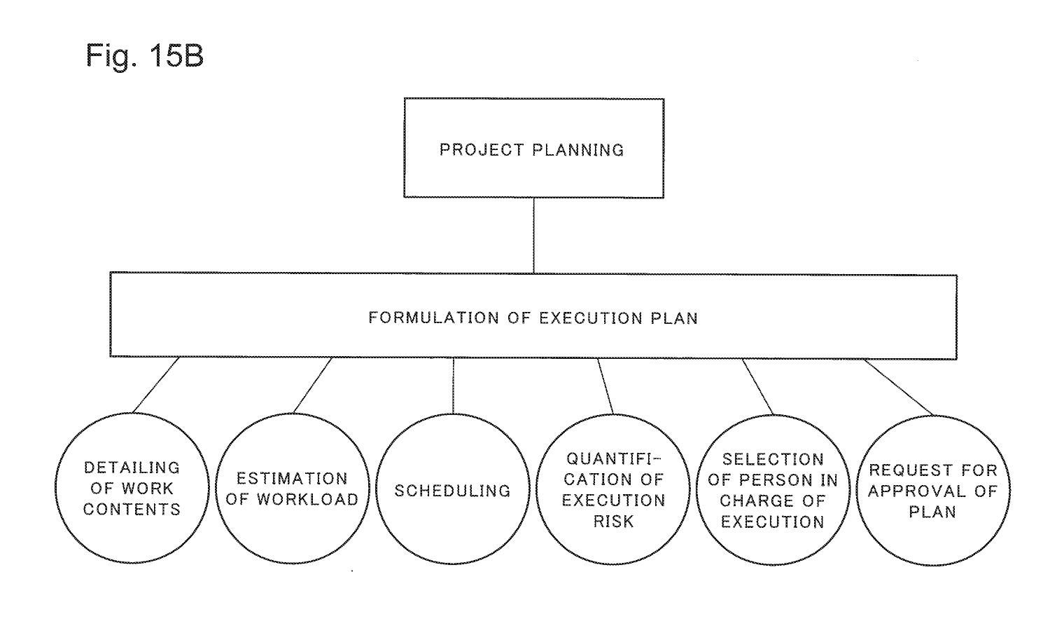

At Step S205, matter-of-concern task model generation unit 110 generates a matter-of-concern task model 211 by using the activity included in the input stakeholder information and the matter of concern and the tasks extracted by matter-of-concern-associated information storage unit 200 through Steps S202 to S204. For example, assume as follows:
The activity of Stakeholder X included in the stakeholder information (see FIG. 10) is “Preparation for Risk management”,
The matter of concern extracted through Steps S202 to S204 is “Risk management” (see FIGS. 11 and 13), and
The group of tasks are “Identification of Related section, Hearing from Related section, and Documentation of Research result” (see FIG. 14). In this case, matter-of-concern task model generation unit 110 generates the tree-structured matter-of-concern task model 211 as illustrated in FIG. 15A, in which:
“Risk management”, which is a matter of concern, serves as a node,
“Preparation for Risk management”, which is an activity, serves as a child node of the matter of concern, and
“Identification of Related section, Hearing from Related section, and Documentation of Research result”, which are a group of tasks, serve as child nodes of the activity.

At Step S206, matter-of-concern task model generation unit 110 stores, in task model storage unit 210, information that associates the stakeholder information (role and activity) used for model generation with the matter-of-concern task model 211 generated at Step S205. For example, when a model generated at the matter-of-concern task model 211 is the tree structure illustrated in FIG. 15A, the information to be stored is information that associates the role “Risk manager in Planning phase” and the activity “Preparation for Risk management” illustrated in FIG. 10 with the model.

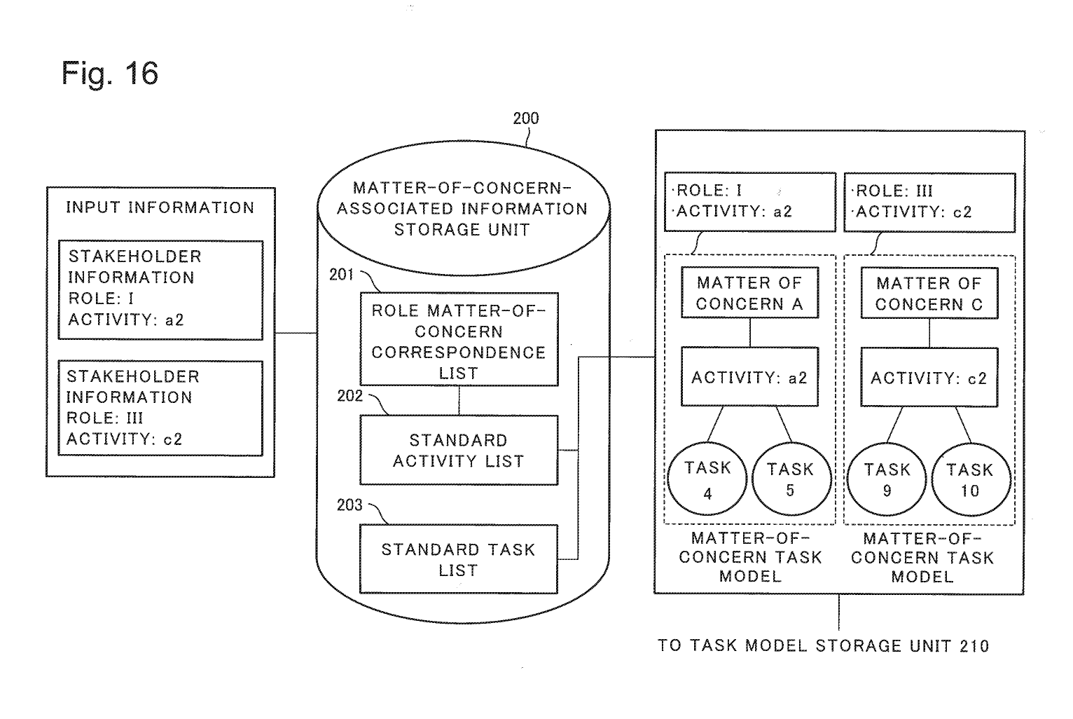

Matter-of-concern-associated information storage unit 200 and matter-of-concern task model generation unit 110 repeat Steps S201 to S206 described above for the number of activities included in the stakeholder information. Matter-of-concern task model generation unit 110 then generates a matter-of-concern task model 211 for the number of times of processing and stores the matter-of-concern task model 211 in task model storage unit 210, as illustrated in FIG. 16. For example, when the present exemplary embodiment is executed for Stakeholder X and Stakeholder Y in FIG. 10, since the number of activities is two, which are “Preparation for Risk management” and “Formulation of Execution plan”, processing through Steps S201 to S206 is executed twice. Then, the matter-of-concern task model 211 illustrated in FIG. 15A and the matter-of-concern task model 211 illustrated in FIG. 15B are generated respectively based on the activity “Preparation for Risk management” and the activity “Formulation of Execution plan”.

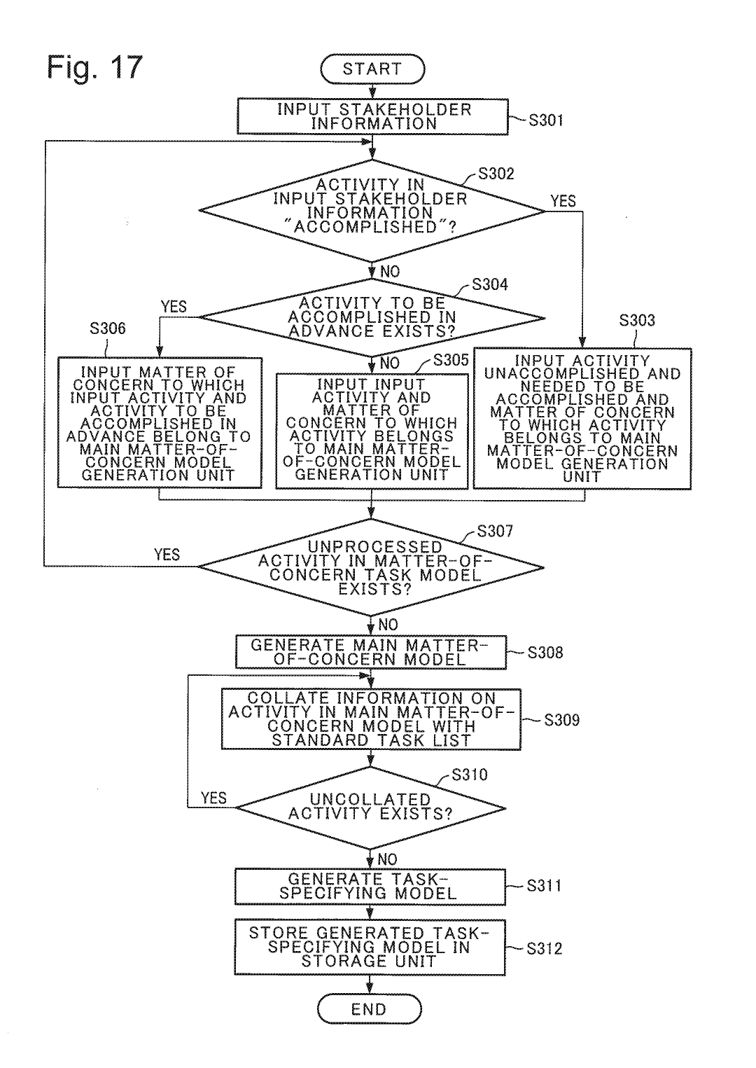

FIG. 17 is a flowchart illustrating an operation (operation at Step S104 in FIG. 8) of generating a task-specifying model 212 in Task-specifying device 1 according to the first exemplary embodiment of the present invention.

First, at Step S301, stakeholder information is input to various stakeholder information input unit 300 through an operation by an operator or the like. Various stakeholder information input unit 300 outputs the input stakeholder information to matter-of-concern-associated information storage unit 200. The stakeholder information includes a role and an activity possessed by each of stakeholders (see FIG. 10).

Next, at Step S302, matter-of-concern-associated information storage unit 200 collates each of activities included in the stakeholder information with accomplished activity list 204 (see FIG. 4). Matter-of-concern-associated information storage unit 200 then specifies an activity which is the same as the activity included in the input stakeholder information from among accomplished activity list 204. At this time, matter-of-concern-associated information storage unit 200 determines whether the specified activity is an accomplished activity or an unaccomplished activity in accomplished activity list 204. When the input activity is “Accomplished” (YES at Step S302) as a result of the determination, matter-of-concern-associated information storage unit 200 proceeds the processing to Step S303. On the other hand, when the input activity is “Unaccomplished” (NO at Step S302), matter-of-concern-associated information storage unit 200 proceeds the processing to Step S304.

At Step S303, matter-of-concern-associated information storage unit 200 inputs, to main matter-of-concern input model generation unit 120, a matter of concern to which an activity among the activities in accomplished activity list 204 that is unaccomplished and to be accomplished in advance of the activity included in the input stakeholder information belongs. An activity to be accomplished in advance refers to an activity newer in a time sequence (t) than the activity included in the stakeholder information. For example, in the activity list 204 in FIG. 4, an activity to be accomplished in advance refers to an activity present on the right side of the activity included in the input stakeholder information. Upon extracting an activity to be accomplished in advance, matter-of-concern-associated information storage unit 200 associates the matter of concern to which the extracted activity belongs with the stakeholder information, and stores the matter of concern and the stakeholder information in main matter-of-concern model generation unit 120.

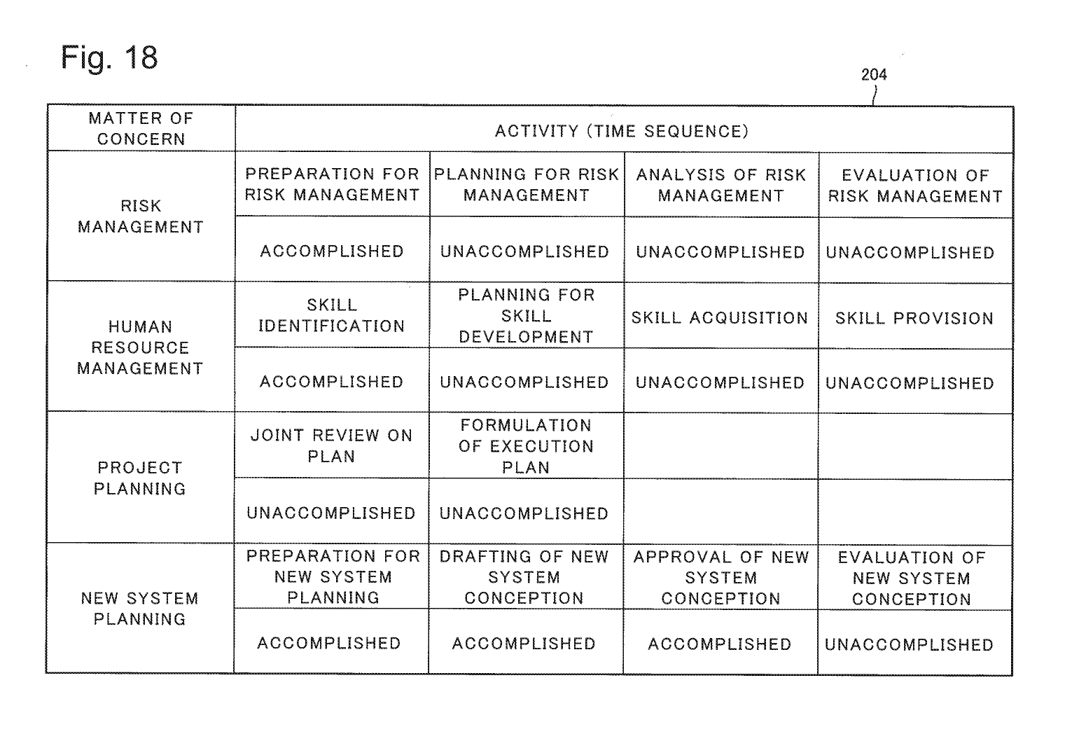

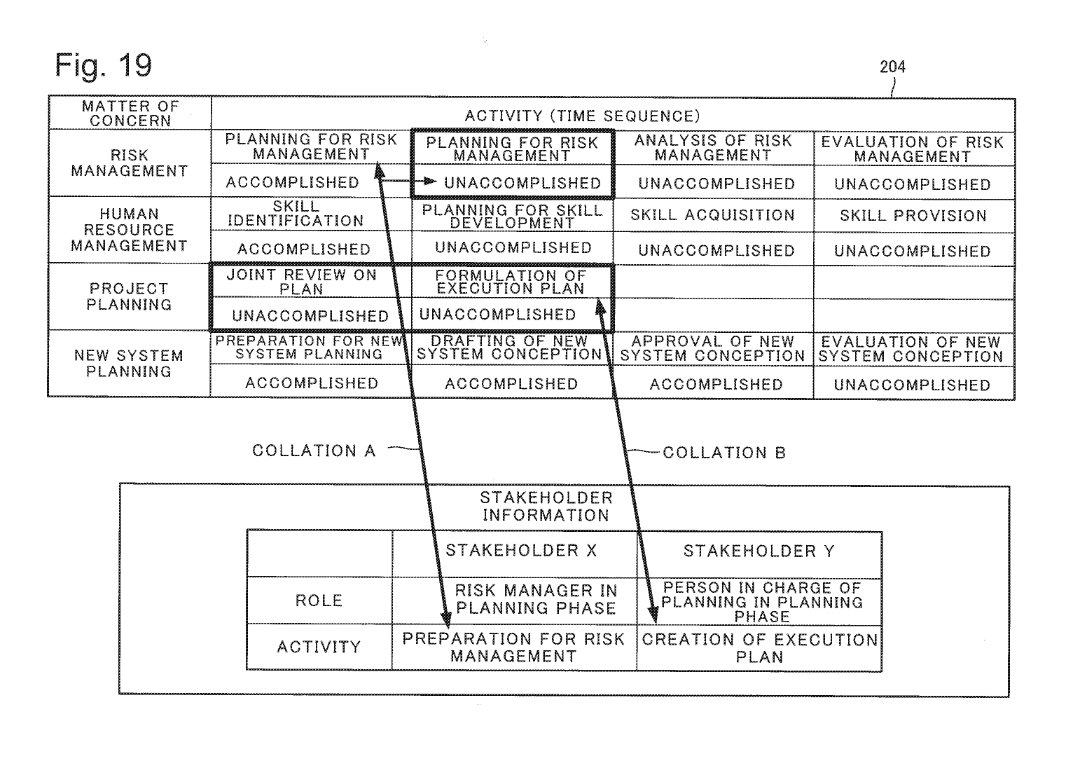

Herein, a specific example of processing at Step S303 is described with reference to FIGS. 18 and 19. FIG. 18 is an explanatory diagram illustrating an example of accomplished activity list 204. FIG. 19 is an explanatory diagram abstractly illustrating a series of flows for processing of collating input stakeholder information with accomplished activity list 204 illustrated in FIG. 18.

Collation A and Collation B illustrated in FIG. 19 indicate collation of activities of respective Stakeholders X and Y. In FIG. 19, the activity of Stakeholder X is “Preparation for Risk management”, which is marked “Accomplished” when collated with accomplished activity list 204 (see FIG. 18). In other words, in the case of Collation A, determination is made YES at Step S302. At this time, at Step S303, in order to extract an activity needed to be accomplished next to “Preparation for Risk management”, an activity that is present on the right side of “Preparation for Risk management” (the right side in FIG. 19) and that is “Unaccomplished” is specified. In this case, the activity “Planning for Risk management” corresponds to an activity which is present on the right side of “Preparation for Risk management” and which is “Unaccomplished”. Matter-of-concern-associated information storage unit 200 extracts “Planning for Risk management”, associates information on “Risk management” which is the matter of concern to which “Planning for Risk management” belongs with the stakeholder information, and stores the information and the stakeholder information in main matter-of-concern model generation unit 120. In addition, matter-of-concern-associated information storage unit 200 changes “Unaccomplished” corresponding to the activity stored in main matter-of-concern model generation unit 120 to “Accomplished” in accomplished activity list 204.

At Step S304, matter-of-concern-associated information storage unit 200 determines whether an activity older in a time sequence (t) than the activity included in the stakeholder information, which is the basis of the determination at Step S302, is present among a group of activities in accomplished activity list 204. In other words, matter-of-concern-associated information storage unit 200 determines whether an activity remaining unaccomplished is present on the left side of the activity included in the stakeholder information, with reference to FIG. 4 as an example. When determining that an activity needed to be accomplished in advance of the activity included in the input stakeholder information is “present” (YES at Step S304), matter-of-concern-associated information storage unit 200 proceeds the processing to Step S306. On the other hand, when determining that an activity needed to be accomplished in advance of the input activity of a stakeholder is “absent” (NO at Step S304), matter-of-concern-associated information storage unit 200 proceeds the processing to Step S305.

At Step S305, matter-of-concern-associated information storage unit 200 extracts the activity included in the stakeholder information, which is the basis of the determination at Step S302, associates information on the matter of concern to which the activity belongs with the stakeholder information, and stores the information and the stakeholder information in main matter-of-concern model generation unit 120. In addition, matter-of-concern-associated information storage unit 200 changes “Unaccomplished” in a portion that corresponds to the extracted activity in accomplished activity list 204 to “Accomplished”.

At Step S306, matter-of-concern-associated information storage unit 200 extracts an activity that is on the left side of the activity included in the stakeholder information, which is the basis of the determination at Step S302, in accomplished activity list 204 illustrated in FIG. 4 and that is unaccomplished, from among a group of activities concerned in accomplished activity list 204. As a result of the extraction, matter-of-concern-associated information storage unit 200 stores, in main matter-of-concern model generation unit 120, information that associates the matter of concern to which the extracted activity belongs with the stakeholder information, and information that associates the activity included in the stakeholder information with information on the matter of concern to which the activity belongs.

Herein, a specific example of processing at Step S306 is described with reference to FIG. 19. In FIG. 19, the activity of Stakeholder Y is “Formulation of Execution plan”, which is marked “Unaccomplished” as a result of collating the activity with accomplished activity list 204. In other words, in the case of Collation B in FIG. 19, determination is made YES at Step S304. At this time, at Step S306, in order to determine the presence/absence of an activity needed to be accomplished in advance of “Formulation of Execution plan”, an activity that is on the left side of “Formulation of Execution plan” (the left side in FIG. 19) and that is “Unaccomplished” is specified. In this case, the activity “Joint review on Plan” corresponds to an activity which is present on the right side of “Formulation of Execution plan” and which is “Unaccomplished”. Hence, matter-of-concern-associated information storage unit 200 extracts information on both the activities “Joint review on Plan” and “Formulation of Execution plan”, associates information on “Project planning” that is the matter of concern to which these activities belong with the stakeholder information, and stores the information and the stakeholder information in main matter-of-concern model generation unit 120. In addition, matter-of-concern-associated information storage unit 200 changes “Unaccomplished” corresponding to the activity stored in main matter-of-concern model generation unit 120 to “Accomplished” in accomplished activity list 204.

Next, at Step S307, matter-of-concern-associated information storage unit 200 determines whether there is an unprocessed piece of the stakeholder information input to matter-of-concern-associated information storage unit 200 at Step S301. When there is an unprocessed piece of the stakeholder information (YES at Step S307), matter-of-concern-associated information storage unit 200 returns the processing to Step S302. Matter-of-concern-associated information storage unit 200 then repeats the processing of Steps 5302 to 5307 described above until processing for all pieces of the input stakeholder information is completed. On the other hand, when there is no unprocessed piece of the stakeholder information (NO at Step S307), matter-of-concern-associated information storage unit 200 proceeds the processing to Step S308.

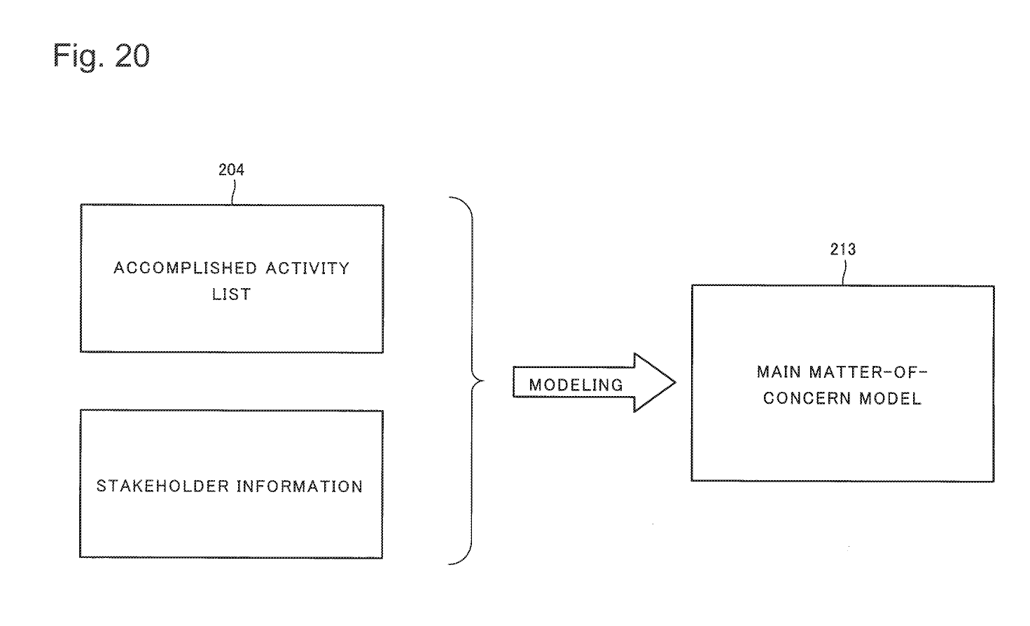

At Step S308, main matter-of-concern model generation unit 120 models a matter of concern at an arbitrary point of time in accomplished activity list 204, which is acquired from matter-of-concern-associated information storage unit 200, and each piece of the stakeholder information, and generates a main matter-of-concern model 213 (see FIG. 6). FIG. 20 is an explanatory diagram abstractly illustrating a series of flows for processing of generating main matter-of-concern model 213 at Step S308.

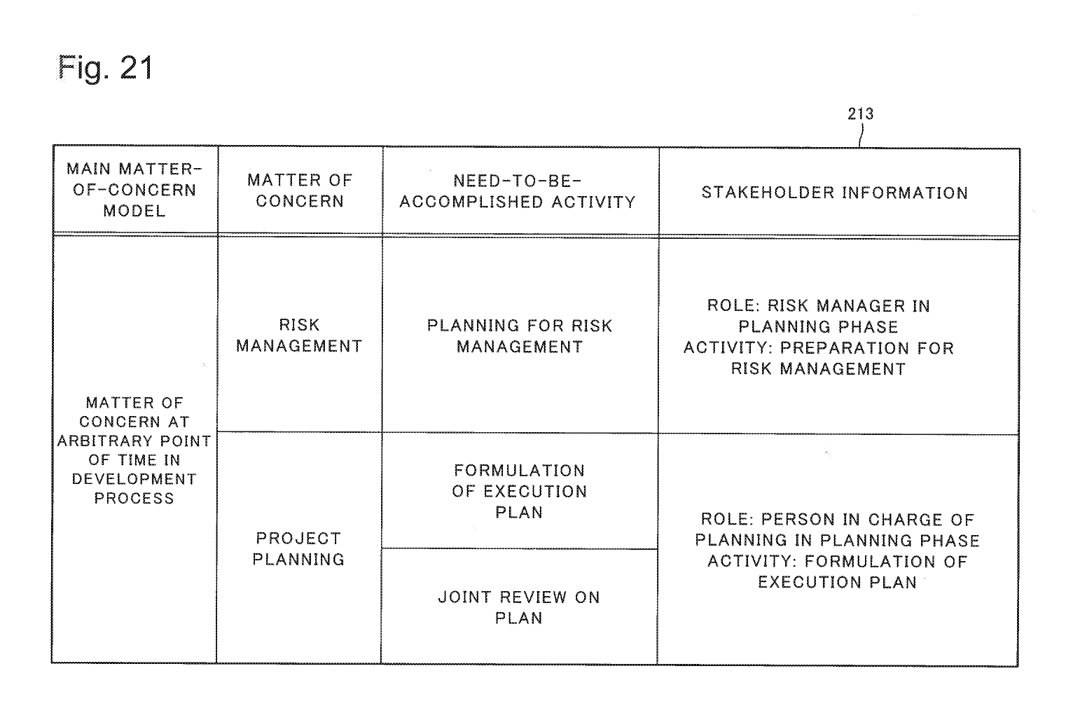

Main matter-of-concern model generation unit 120 inputs the generated main matter-of-concern model 213 to task-specifying model generation unit 130. With reference to FIG. 21 for detailed description, main matter-of-concern model generation unit 120 stores main matter-of-concern model 213 for each piece of the stakeholder information input at an arbitrary point of time in a development process. Main matter-of-concern model 213 is one set of information extracted through Steps S301 to S307, including a matter of concern relating to a main matter of concern, an activity constituting the matter of concern, and stakeholder information which is the basis of extraction of the activity. Note that an activity constituting a matter of concern refers to a need-to-be-accomplished activity. Stakeholder information which is the basis of extraction of an activity refers to a role and an activity.

At Step S309, task-specifying model generation unit 130 collates information on each of the activities constituting main matter-of-concern model 213 acquired from main matter-of-concern model generation unit 120 with standard task list 203 (see FIG. 3D). For example, when main matter-of-concern model 213 that main matter-of-concern model generation unit 120 stores includes contents illustrated in FIG. 21, task-specifying model generation unit 130 inputs “Planning for Risk management”, which is an activity in main matter-of-concern model 213, to matter-of-concern-associated information storage unit 200. Task-specifying model generation unit 130 then collates the input activity “Planning for Risk management” with standard task list 203 illustrated in FIG. 14. According to a result of the collation, task-specifying model generation unit 130 extracts, as tasks, “Definition of Management policy”, “Request for Approval of Management policy”, “Documentation of Process”, “Division of Roles of Process practitioner”, and “Selection of Person in charge of Risk management”, which are information on tasks in which “Planning for Risk management” is detailed, from matter-of-concern-associated information storage unit 200.

Next, at Step S310, task-specifying model generation unit 130 determines whether activity information which is uncollated with standard task list 203 of matter-of-concern-associated information storage unit 200 is present in main matter-of-concern model 213. When there is uncollated activity information (YES at Step S310), task-specifying model generation unit 130 returns the processing to Step S309. Task-specifying model generation unit 130 then repeats the processing of Steps 5309 to S310 until collation processing for the activities constituting main matter-of-concern model 213 is completed. On the other hand, when there is no uncollated activity (NO at Step S310), task-specifying model generation unit 130 proceeds the processing to Step S311.

At Step S311, task-specifying model generation unit 130 generates a task-specifying model 212 (see FIG. 7) by using main matter-of-concern model 213 generated through Steps 5301 to 5308 and the tasks extracted at Step S309. Task-specifying model generation unit 130 then associates the role and the activity, which are the stakeholder information in main matter-of-concern model 213, with the activity in task-specifying model 212.

For example, when main matter-of-concern model 213 generated through Steps S301 to S308 includes contents illustrated in FIG. 21, tasks to be extracted at Step S309 are as follows:
Tasks relating to Activity “Preparation for Risk management”

“Definition of Management policy, Request for Approval of Management policy, Documentation of Process, Division of Roles of Process practitioner, Selection of Person in charge of Risk management”
Tasks relating to Activity “Formulation of Execution plan”

“Detailing of Work contents, Estimation of Workload, Scheduling, Quantification of Execution risk, Selection of a Person in charge of Execution, Request for Approval of Plan”, and
Tasks relating to Activity “Joint review on Plan”

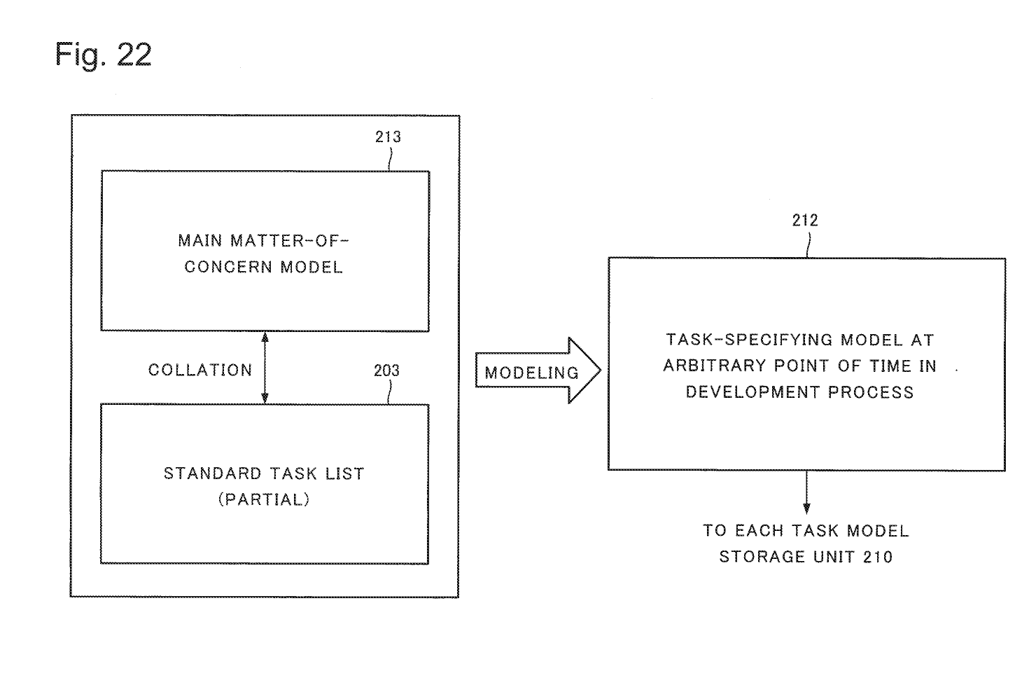

“Definition of Review method, Selection of Reviewer, Scheduling”. Task-specifying model generation unit 130 generates task-specifying model 212 at an arbitrary point of time in a development process, based on main matter-of-concern model 213 and information on the tasks in standard task list 203. FIG. 22 is an explanatory diagram abstractly illustrating a series of flows for processing of generating a task-specifying model 212 (see FIG. 7) by using main matter-of-concern model 213 (see FIG. 6) and standard task list 203 (see FIG. 3D) through Steps S309 to S311.

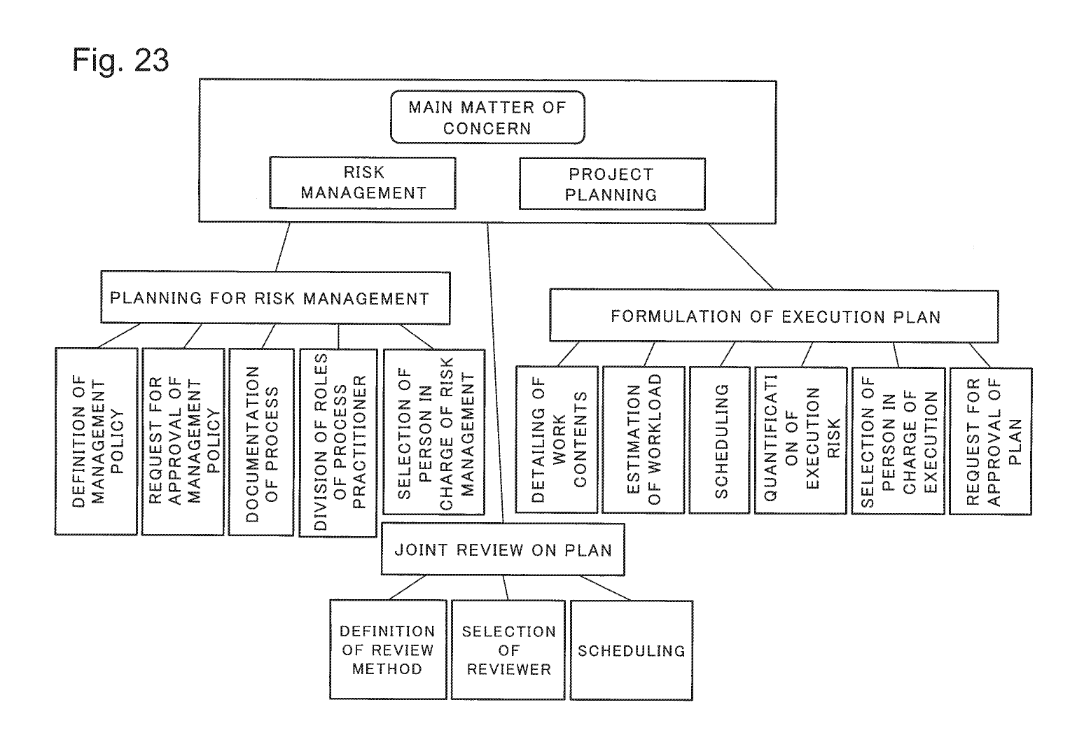

FIG. 23 is an explanatory diagram illustrating an example of task-specifying model 212. As illustrated in FIG. 23, task-specifying model 212 is a model that is structuralized using a tree structure, in which:
“Risk management” and “Project”, which are a main matter of concern at an arbitrary point of time, serve as nodes,
Activities “Planning for Risk management”, “Formulation of Execution plan”, and “Joint review on Plan” serve as child nodes of the main matter of concern, and
Tasks in the following serve as child nodes of each of the activities:

“Definition of Management policy, Request for Approval of Management policy, Documentation of Process, Division of Roles of Process practitioner, Selection of Person in charge of Risk management”,

“Detailing of Work contents, Estimation of Workload, Scheduling, Quantification of Execution risk, Selection of a Person in charge of Execution, Request for Approval of Plan”, and

“Definition of Review method, Selection of Reviewer, Scheduling”.

At Step S312, task-specifying model generation unit 130 stores, in task model storage unit 210, information that associates the role and the activity included in the stakeholder information with task-specifying model 212 generated at Step S311.

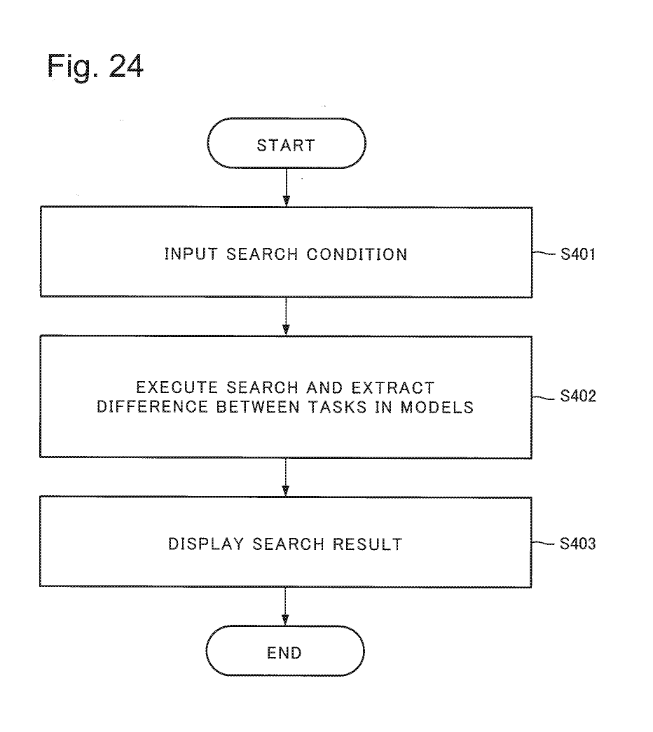

FIG. 24 is a flowchart illustrating an operation of searching a matter-of-concern task model 211 and a task-specifying model 212 by Task-specifying device 1 according to the present exemplary embodiment.

First, at Step S401, stakeholder information as a search condition is input to search condition input unit 310 through an operation by an operator or the like. Search condition input unit 310 passes over the input stakeholder information to task extraction unit 140. For example, when tasks associated with Stakeholder X and Stakeholder Y illustrated in FIG. 10 are extracted, the role “Risk manager in Planning phase” and the activity “Planning for Risk management” of Stakeholder X are input. Further, the role “a Person in charge of Planning in Planning phase” and the activity “Formulation of Execution plan” of Stakeholder Y are input.

Next, at Step S402, task extraction unit 140 searches task model storage unit 210 based on the stakeholder information input from search condition input unit 310, and extracts a matter-of-concern task model 211 and a task-specifying model 212 associated with the search condition. Task extraction unit 140 then compares, based on task-specifying model 212, tasks in the matter-of-concern task model 211 with tasks in task-specifying model 212, and extracts a difference therebetween (difference task). The result of the extraction is a task which is missing from the matter-of-concern task model 211. Task extraction unit 140 then outputs information on the extracted task and information on the matter-of-concern task model 211 and task-specifying model 212 associated with the search condition to display unit 320.

For example, assume that information on Stakeholder X and Stakeholder Y illustrated in FIG. 10 is input as a search condition, and the matter-of-concern task model 211 illustrated in FIGS. 15A and 15B and task-specifying model 212 illustrated in FIG. 23 are extracted from task model storage unit 210 as a result of the search. In this case, it is found that tasks which are missing from the recognition of Stakeholder X and Stakeholder Y are “Definition of Review method, Selection of Reviewer, and Scheduling” which belong to the activity “Joint review on Plan”.

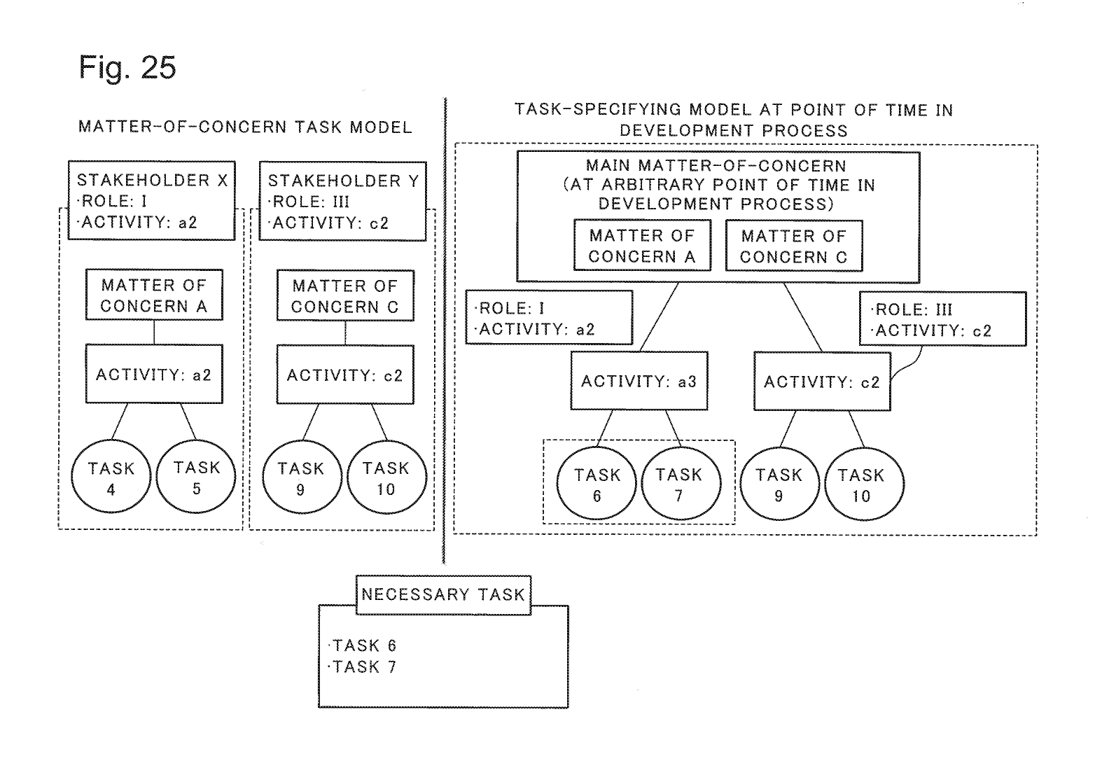

At Step S403, when the matter-of-concern task model 211 for each of the stakeholders, task-specifying model 212 and the tasks which are missing from the recognition of each of the stakeholders are input from task extraction unit 140, display unit 320 displays information indicating the contents thereof. An example of a display screen is illustrated in FIG. 25. FIG. 25 is a diagram illustrating an example of the screen for displaying the content of the difference task.

The advantageous effect of the first exemplary embodiment of the present invention is described. As described above, in the present exemplary embodiment, tasks which are recognized by each stakeholder involved in a development process at an arbitrary point of time are compared with unaccomplished tasks of the development process at the point of time to extract a difference therebetween. Based on the extracted difference, a task which is needed for consensus building and information conveyance in a collaborative work between stakeholders in service development and system development and which is missing from the recognition of each of the stakeholders at an arbitrary point of time of development is specified. This enables promotion of consensus building and information conveyance between stakeholders.

In addition, in the present exemplary embodiment, task-based management is made possible, rather than a process-based development method. This facilitates guidance and management of development involving collaboration between stakeholders, such as iterative development and agile development.

### Second Exemplary Embodiment

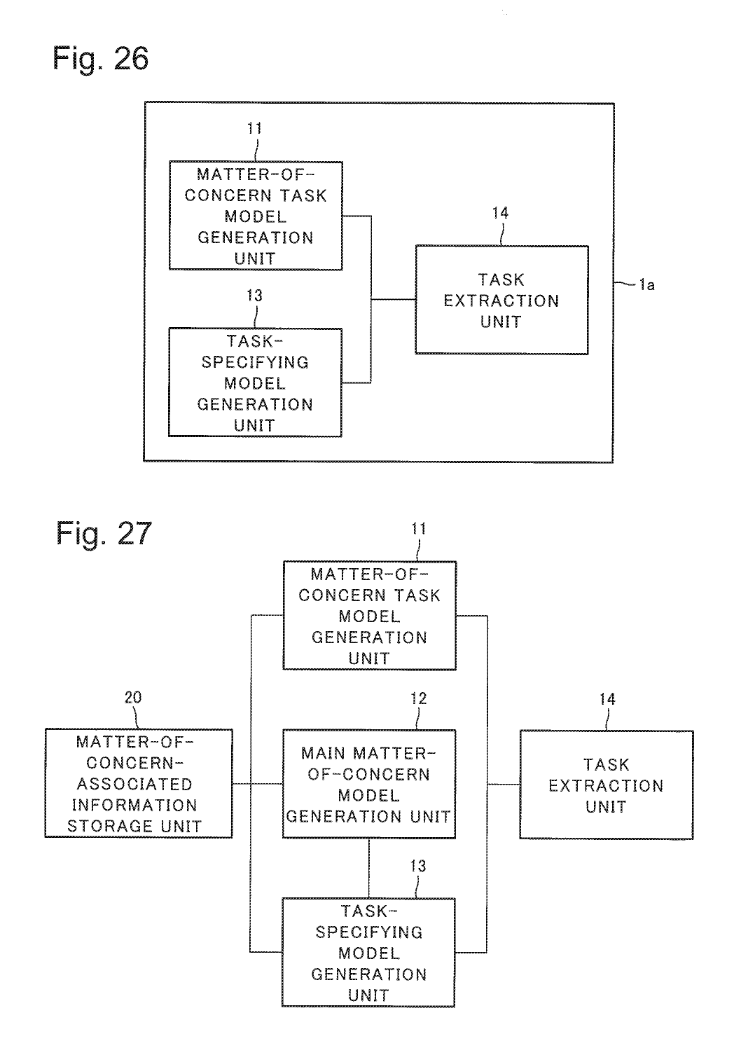

Next, a task-specifying device 1a according to a second exemplary embodiment of the present invention is described. Task-specifying device 1a illustrated in FIG. 26 is a block diagram of the minimum-configuration task-specifying device 1 illustrated in FIG. 1. Task-specifying device 1a includes matter-of-concern task model generation unit 11 (equivalent to matter-of-concern task model generation unit 110 illustrated in FIG. 1), task-specifying model generation unit 13 (equivalent to task-specifying model generation unit 130 illustrated in FIG. 1), and task extraction unit 14 (equivalent to task extraction unit 140 illustrated in FIG. 1).

Matter-of-concern task model generation unit 11 generates a matter-of-concern task model that structuralizes a relationship among an activity included in stakeholder information indicating a content of an action of a stakeholder, a matter of concern to which the activity belongs, and tasks detailing the activity.

Task-specifying model generation unit 13 generates a task-specifying model that structuralizes a relationship among a matter of concern needed at an arbitrary point of time in a development process, an activity to be accomplished relating to the needed matter of concern, and tasks detailing the activity.

Task extraction unit 14 compares tasks in the matter-of-concern task model with tasks in the task-specifying model and extracts a difference.

The advantageous effect of the second exemplary embodiment of the present invention is described. In the present exemplary embodiment, tasks which are recognized by each stakeholder involved in a development process at an arbitrary point of time are compared with unaccomplished tasks of the development process at the point of time to extract a difference therebetween. Based on the extracted difference, a task which is needed for consensus building and information conveyance in a collaborative work between stakeholders in service development and system development and which is missing from the recognition of each of the stakeholders at an arbitrary point of time of development is specified. This enables promotion of consensus building and information conveyance between stakeholders.

In addition, the present exemplary embodiment may further include a search condition input unit (equivalent to search condition input unit 310 illustrated in FIG. 1), and

a task model storage unit (equivalent to task model storage unit 210 illustrated in FIG. 1) that stores a matter-of-concern task model and a task-specifying model, wherein task extraction unit 14 may extract, based on a search condition input to the search condition input unit, a difference between tasks in the matter-of-concern task model and the task-specifying model which are searched from the task model storage unit.

Such a configuration makes it possible to arbitrarily change a search target through an operation by an operator or the like, enabling further accurate specification of a task which is more needed for consensus building and information conveyance in a collaborative work between stakeholders.

In addition, the present exemplary embodiment may further include a display unit (equivalent to display unit 320 illustrated in FIG. 1) that displays information indicating a difference between tasks in the matter-of-concern task model and the task-specifying model extracted by task extraction unit 14.

Such a configuration enables recognition of a difference between tasks which are recognized by each stakeholder involved in a development process at an arbitrary point of time with unaccomplished tasks of the development process at the point of time, by means of a display device such as a display. This makes it possible to further facilitate specification of a task which is needed for consensus building and information conveyance in a collaborative work between stakeholders and which is missing from the recognition of each of the stakeholders.

FIG. 27 is a block diagram illustrating a modification example of the task-specifying device according to the second exemplary embodiment of the present invention. As illustrated in FIG. 27, the modification example of the task-specifying device according to the present exemplary embodiment includes
matter-of-concern task model generation unit 11 (equivalent to matter-of-concern task model generation unit 110),
main matter-of-concern model generation unit 12 (equivalent to main matter-of-concern model generation unit 120),
task-specifying model generation unit 13 (equivalent to task-specifying model generation unit 130),
matter-of-concern-associated information storage unit 20 (equivalent to matter-of-concern-associated information storage unit 200), and
task extraction unit 14 (equivalent to task extraction unit 140).

Matter-of-concern task model generation unit 11 generates a model that structuralizes a relationship among an activity indicating a content of an action of a stakeholder, a matter of concern to which the activity belongs, and tasks detailing the activity into execution contents.

Main matter-of-concern model generation unit 12 generates a matter-of-concern task model that structuralizes a matter of concern constituting a main matter of concern and an activity constituting the matter of concern, at an arbitrary point of time in a development process.

Task-specifying model generation unit 13 generates a task-specifying model that structuralizes a matter of concern constituting a main matter of concern, an activity constituting the matter of concern, and tasks detailing the activity, at an arbitrary point of time in a development process.

Matter-of-concern-associated information storage unit 20 holds information necessary for model generation in matter-of-concern task model generation unit 11, main matter-of-concern model generation unit 12, and task-specifying model generation unit 13.

Task extraction unit 14 compares tasks in the matter-of-concern task model for each stakeholder with tasks in the task-specifying model, and extracts a difference.

The advantageous effect of the modification example of the second exemplary embodiment of the present invention is described. In the modification example of the present exemplary embodiment, tasks which are recognized by each stakeholder involved in a development process at an arbitrary point of time of development are compared with unaccomplished tasks of the development process at the point of time to extract a difference therebetween. Based on the extracted difference, a task which is needed for consensus building and information conveyance in a collaborative work between stakeholders in service development and system development and which is missing from the recognition of each of the stakeholders at an arbitrary point of time of development can be specified. This enables promotion of consensus building and information conveyance between stakeholders.

In the modification example of the present exemplary embodiment, further,

matter-of-concern-associated information storage unit 20 may hold a role matter-of-concern correspondence list (equivalent to role matter-of-concern correspondence list 201 illustrated in FIG. 1), a standard activity list (equivalent to standard activity list 202), a standard task list (equivalent to standard task list 203), and an accomplished activity list (equivalent to accomplished activity list 204),

matter-of-concern task model generation unit 11 may generate, based on the role matter-of-concern correspondence list, the standard activity list, and the standard task list, a matter-of-concern task model based on a role and an activity included in stakeholder information,

main matter-of-concern model generation unit 12 may generate a main matter-of-concern model based on the accomplished activity list, and

task-specifying model generation unit 13 may generate a task-specifying model based on the main matter-of-concern model at an arbitrary point of time in a development process and the standard task list.

Such a configuration makes it possible to apply the present invention to various types of service development and system development by, for example, storing each of the lists in matter-of-concern-associated information storage unit 20 in accordance with a type of service development and system development.

The modification example of the present exemplary embodiment may further include
a search condition input unit (equivalent to Search condition input unit 310 illustrated in FIG. 1), and
a task model storage unit (equivalent to task model storage unit 210) that stores a matter-of-concern task model and a task-specifying model, wherein
task extraction unit 14 may extract, based on a search condition input to the search condition input unit, a difference between tasks in the matter-of-concern task model and the task-specifying model which are searched from the task model storage unit.

Such a configuration enables further accurate specification of a task which is more needed for consensus building and information conveyance in a collaborative work between stakeholders by arbitrarily changing a search target through an operation by an operator or the like.

The modification example of the present exemplary embodiment may further include a display unit (equivalent to display unit 320 illustrated in FIG. 1) that displays information indicating a difference between tasks in the matter-of-concern task model and the task-specifying model extracted by task extraction unit 14.

Such a configuration recognizes a difference between tasks which are recognized by each stakeholder involved in a development process at an arbitrary point of time with unaccomplished tasks of the development process at the point of time, by means of a display device such as a display. This further facilitates specification of a task which is needed for consensus building and information conveyance in a collaborative work between stakeholders and which is missing from the recognition of each of the stakeholders.

The present invention has been described using each of the exemplary embodiments described above as an exemplary example. However, the present invention is not limited to the above-described exemplary embodiments. In other words, various modes that a person skilled in the art can understand can be applied to the present invention within the scope of the present invention.

This application is based upon and claims the benefit of priority from Japanese Patent Application No. 2014-087444, filed on Apr. 21, 2014, the disclosure of which is incorporated herein in its entirety.

### REFERENCE SIGNS LIST

1, 1a task-specifying device
11, 110 matter-of-concern task model generation unit
12, 120 main matter-of-concern model generation unit
13, 130 task-specifying model generation unit
14, 140 task extraction unit
20, 200 matter-of-concern-associated information storage unit
201 role matter-of-concern correspondence list
202 standard activity list
203 standard task list
204 Accomplished activity list
210 task model storage unit
211 matter-of-concern task model
212 task-specifying model
213 main matter-of-concern model
300 various stakeholder information input unit
310 search condition input unit
320 display unit

What is claimed is:

1. A task-specifying device comprising:
a memory storing instructions; and
one or more processors acting as a matter-of-concern task model generation unit configured to generate a matter-of-concern task model that structuralizes a relationship among an activity included in stakeholder information indicating a content of an action of a stakeholder, a matter of concern to which the activity belongs, and a task detailing the activity;
the one or more processors acting as a task-specifying model generation unit configured to generate a task-specifying model that structuralizes a relationship among a matter of concern needed at an arbitrary point of time in a development process, an activity to be accomplished relating to the needed matter of concern, and a task detailing the activity; and
the one or more processors acting as a task extraction unit configured to compare a task in the matter-of-concern task model with a task in the task-specifying model and extracts a difference between the tasks.

2. The task-specifying device according to claim 1, wherein
an activity in the matter-of-concern task model generated by the matter-of-concern task model generation unit includes a task detailing an execution content of the activity,
the task-specifying model generated by the task-specifying model generation unit includes a main matter of concern which is a superordinate concept of a group of matters of concern constituted of one or more of the needed matter of concern,
the task extraction unit compares the task in the matter-of-concern task model relating to a plurality of the stakeholders with the task in the task-specifying model and extracts the difference, and the one or more processors further acting as
a main matter-of-concern model generation unit configured to generate a main matter-of-concern model that structuralizes the main matter of concern, one or more of the needed matters of concern relating to the main matter of concern, and an activity constituting the needed matters of concern; and
the one or more processors further acting as a matter-of-concern-associated information storage unit configured to hold information necessary for model generation in the matter-of-concern task model generation unit, the main matter-of-concern model generation unit, and the task-specifying model generation unit.

3. The task-specifying device according to claim 2, wherein
the matter-of-concern-associated information storage unit holds a role matter-of-concern correspondence list, a standard activity list, a standard task list, and an accomplished activity list,
the matter-of-concern task model generation unit, generates by using a role and the activity included in the stakeholder information, the matter-of-concern task model from the role matter-of-concern correspondence list, the standard activity list, and the standard task list,
the main matter-of-concern model generation unit generates the main matter-of-concern model, based on the accomplished activity list, and
the task-specifying model generation unit generates the task-specifying model, based on the main matter-of-concern model at an arbitrary point of time in a development process and the standard task list.

4. The task-specifying device according to claim 1, further comprising:
a search condition input unit;
a task model storage unit configured to store the matter-of-concern task model and the task-specifying model; and
the task extraction unit further configured to extract the difference between the tasks in the matter-of-concern task model and the task-specifying model which are searched from the task model storage unit based on a search condition input to the search condition input means.

5. The task-specifying device according to claim 1, the one or more processors further acting as:
a display unit configured to display information indicating a difference in tasks between the matter-of-concern task model and the task-specifying model which are extracted by the task extraction unit.

6. A task-specifying method comprising:
generating a matter-of-concern task model that structuralizes a relationship among an activity included in stakeholder information indicating a content of an action of a stakeholder, a matter of concern to which the activity belongs, and a task detailing the activity;
generating a task-specifying model that structuralizes a relationship among a matter of concern needed at an arbitrary point of time in a development process, an activity to be accomplished relating to the needed matter of concern, and a task detailing the activity; and
comparing a task in the matter-of-concern task model with a task in the task-specifying model and extracting a difference.

7. A non-transitory computer-readable recording medium that stores a task-specifying program causing a computer to execute processing of:
generating a matter-of-concern task model that structuralizes a relationship among an activity included in stakeholder information indicating a content of an action of a stakeholder, a matter of concern to which the activity belongs, and a task detailing the activity;
generating a task-specifying model that structuralizes a relationship among a matter of concern needed at an arbitrary point of time in a development process, an activity to be accomplished relating to the needed matter of concern, and a task detailing the activity; and
comparing a task in the matter-of-concern task model with a task in the task-specifying model and extracting a difference.

8. The task-specifying device according to claim 2, further comprising:
a search condition input unit;
a task model storage unit configured to store the matter-of-concern task model and the task-specifying model; and
the task extraction unit further configured to extract the difference between the tasks in the matter-of-concern task model and the task-specifying model which are searched from the task model storage unit based on a search condition input to the search condition input means.

9. The task-specifying device according to claim 3, further comprising:
a search condition input unit;
a task model storage unit configured to store the matter-of-concern task model and the task-specifying model; and
the task extraction unit further configured to extract the difference between the tasks in the matter-of-concern task model and the task-specifying model which are searched from the task model storage unit based on a search condition input to the search condition input means.

10. The task-specifying device according to claim 2, the one or more processors further acting as:
a display unit configured to display information indicating the difference in the tasks between the matter-of-concern task model and the task-specifying model which are extracted by the task extraction unit.

11. The task-specifying device according to claim 3, the one or more processors further acting as:
a display unit configured to display information indicating the difference in the tasks between the matter-of-concern task model and the task-specifying model which are extracted by the task extraction unit.

12. The task-specifying device according to claim 4, the one or more processors further acting as:
a display unit configured to display information indicating the difference in the tasks between the matter-of-concern task model and the task-specifying model which are extracted by the task extraction unit.
